(19) United States
(12) Patent Application Publication
(10) Pub. No.: US 2010/0245252 A1
(43) Pub. Date: Sep. 30, 2010

(54) Information input keyboard and keyboard locator associated therewith

(76) Inventor: Yoram Ghassabian, Great Neck, NY (US)

Correspondence Address: Aleksandr Smushkovich, POB 140505, Brooklyn, NY, 11214, US

(21) Appl. No.: 12/657,147

(22) Filed: Jan. 13, 2010

Related U.S. Application Data
(60) Provisional application No. 61/211,220, filed on Mar. 30, 2009.

(51) Int. Cl. G06F 3/02

(52) U.S. Cl. 345/169

(57) ABSTRACT

A processing (e.g. telecommunication) device is herein proposed. The device comprises a display, and a keyboard peripherally extending around at least a portion of display. Preferably, the keyboard is alphanumerical and extends around at least a portion the display's perimeter. The alphanumerical keyboard preferably has a predetermined keyboard set of keys, and the device further comprises a keyboard locator unit having a locator set of keys corresponding to the predetermined keyboard set of keys. The keys of the locator set of keys are disposed in a manner to indicate the locations of the keys of the predetermined keyboard set of keys. The device may comprise a microphone and a speaker located on opposite sides thereof, the display extends therebetween, the keyboard extends around at least a portion of the display's sides. The keyboard and the locator unit can be represented as a mechanical unit, or an image on the display.

### CROSS REFERENCE TO RELATED APPLICATIONS

The present U.S. utility patent application claims the benefit under 35 USC 119 (e) of a U.S. provisional patent application No. 61/211,220 filed on 30 Mar. 2009, whose disclosure is hereby incorporated by reference in its entirety. This application also contains newly disclosed ramifications that do not claim the aforesaid benefit.

### FIELD OF THE INVENTION

The instant invention relates to keyboard devices, particularly to keyboard devices acting as periphery units combined with a cellular telephone, a computer (preferably of a small size, such as a palm computer), a PDA, a touch screen smart phone, and other similar communication devices.

### BACKGROUND OF THE INVENTION

There is known U.S. Pat. No. 6,630,895 describing: ‘A keyboard assembly includes a wireless USB (Universal Serial Bus) based keyboard having an upper face on which push buttons are movably mounted. A recess is defined in the upper face of the keyboard. A display is sized to be received in the recess. The display may be fixed in the recess. Alternately, the display is pivoted to the keyboard and movable between an erected position for user's observation and a stowed position where the display is received in the recess. The keyboard and the display are controlled by a common USB face side control circuit thereby enabling the keyboard to receive and display video signals without additional circuit.’

Another U.S. Pat. No. 7,227,535 teaches ‘A keyboard and display for a computer includes a housing having a top wall, a bottom wall, a back wall, a first side wall, a second side wall, and a front wall. A processor is mounted within the housing. A plurality of keys defining a computer keyboard is positioned in the top wall and is substantially flush with the top wall. Each of the keys comprises a touch sensitive key and each is electrically coupled to the processor. A display is mounted in the top wall and is substantially flush with the top wall. The display is electrically coupled to the processor. A face side is electrically coupled to the processor and selectively coupled to the computer for communication between the processor and the computer. The computer may receive input from the plurality of keys and a video signal received from the computer may be displayed on the display.’

Another U.S. Pat. No. 4,274,093 teaches ‘A keyboard is constructed as an integral member of a display screen. The keyboard comprises a number of keys which are back-lighted upon the screen when they are enabled, but which are otherwise invisible to the viewer when disabled. When a key is depressed, the lit keyboard is reconfigured, a new set of keys enabled, and a system function is performed.’

Yet, another U.S. Pat. No. D505,417 illustrates ‘a keypad for a cellular phone’ with mechanical key buttons situated on the outside boundaries of two sides of a display area of a device. The keypad consists of two rows of alphanumerical keys outwardly situated at the left and right sides of the display area.

The aforementioned devices have several disadvantages. For example, a keyboard ‘constructed as an integral member of a display screen’ occupies a significant portion of the small display area of a cellular phone (such as Black Berry® and Apple iPhone®) hindering the view of a screen image when the user needs to type something, e.g., in a text box on the screen. Keypads, consisting of two rows of keys outwardly situated at two sides of the screen, necessarily have keys, wherein each of the keys mostly refers to three different alphabetical characters that create inconvenience for pressing the keys several times or for switching the sets of characters, etc. Moreover, the keypads consisting of two rows of keys situated only at two sides of the screen do not use the entire possible length available around the periphery of the screen in order to place a greater number of keys, and/or to provide substantially larger dimensions for the keys.

### INVENTOR'S DEFINITIONS

Herein, an ‘ambiguous’ key means a keyboard's key comprising at least two alphabetical characters and which is capable to produce various alphabetical characters when it is selected by the user. Herein an ‘unambiguous’ key means a keyboard's key comprising only one alphabetical character and which is capable to produce only one alphabetical character when it is selected by the user. Herein, for rectangular-shaped displays (screens), the longer side of the rectangle is called a ‘longitudinal’ side, and the shorter side is respectively called a ‘transversal’ side.

### OBJECTS AND BRIEF SUMMARY OF THE INVENTION

The primary aim of the present invention is to provide a keyboard for a telecommunication, computing, or similar device, herein also collectively called a ‘processing device’, having a screen (display), which would enable a user to quickly and conveniently enter characters/symbols in a particular place of the screen by providing a non-invasive peripheral keyboard, having preferably one alphabetical character per key, and having keys with largest possible dimensions around the screen (display). Other aims of the invention might become apparent to one skilled in the art upon learning the present disclosure.

Accordingly, a processing device is herein proposed. The device comprises a display, and a keyboard peripherally extending around at least a portion of display. Preferably, the keyboard is alphanumerical and extends around at least a portion the display's perimeter. The alphanumerical keyboard preferably has a predetermined keyboard set of keys, and the device further comprises a keyboard locator unit having a locator set of keys corresponding to the predetermined keyboard set of keys. The keys of the locator set of keys are disposed in a manner to indicate the locations of the keys of the predetermined keyboard set of keys. The device may comprise a microphone and a speaker located on opposite sides thereof, the display extends therebetween, the keyboard extends around at least a portion of the display's sides. The keyboard and the locator unit can be represented as a mechanical unit, or an image on the display. Various other embodiments are also disclosed and claimed herein.

### BRIEF DESCRIPTION OF DRAWINGS

FIG. 1 illustrates a schematic view of the proposed keyboard according to a preferred embodiment of the present invention, wherein the hardware keyboard, having one alphabetical character per key, extends around a substantial portion of the four sides of the display. The keyboard is arranged in a regular alphabetical order.

FIG. 2 illustrates a schematic view of the proposed keyboard according to another preferred embodiment of the present invention, wherein the hardware keyboard, having one alphabetical character per key, extends around a substantial portion of the four sides of the display. The keyboard is arranged in a continuous Qwerty order.

FIG. 3 illustrates a schematic view of the proposed keyboard according to another preferred embodiment of the present invention, wherein the keyboard is peripherally arranged, and has two units: a visible keyboard locator unit and an invisible keyboard unit.

FIG. 4 illustrates a schematic view of the proposed keyboard according to another preferred embodiment of the present invention, wherein the peripheral keyboard is made of several ambiguous keys and also of their respective unambiguous keys, which are preferably located next to and/or inside the ambiguous keys.

FIG. 5 illustrates a schematic view of the proposed keyboard according to another preferred embodiment of the present invention, wherein the peripheral keyboard is made of four predeterminedly larger ambiguous keys for entering any data as a first step, and small unambiguous keys and predeterminedly large ambiguous keys for adding to and/or correcting the data.

FIG. 6 illustrates a schematic view of the proposed keyboard according to another preferred embodiment of the present invention, wherein the peripheral keyboard follows a predeterminedly narrow/wider unambiguous key pattern.

FIG. 7 illustrates a schematic view of the proposed keyboard according to another preferred embodiment of the present invention, wherein the keyboard locator unit of the peripheral keyboard has a two-row configuration in order to indicate the location of any invisible touch screen keys anywhere on the display.

FIG. 8 illustrates a schematic view of the proposed device, according to another preferred embodiment of the present invention, wherein the proposed device comprises a hardware frame, a display, an image keyboard (arranged peripherally on the display) having invisible display keys, and a keyboard locator unit located on the hardware frame, and wherein any of the invisible display keys becomes visible when the tip of the user's finger is detected over its location on the display.

FIG. 9 illustrates a schematic view of the proposed keyboard according to another preferred embodiment of the present invention, wherein the keyboard locator unit of the peripheral keyboard appears as an image in the shape of a predeterminedly thin line extending on and around the display.

FIG. 10 illustrates a schematic view of the proposed keyboard according to another preferred embodiment of the present invention, wherein the keyboard locator unit and the invisible display keyboard unit of the peripheral keyboard are divided into four separate portions which extend around a substantial part of each of the four corners of the device.

FIG. 11 illustrates a schematic view of the proposed keyboard according to another preferred embodiment of the present invention, wherein the user selects the “Edit” key appearing on the image keyboard locator, and the selection is followed by the opening of a window application relating to the “Edit” key in which the “Cut”, “Copy” and “Paste” commands appear.

FIG. 12 illustrates a schematic view of the proposed keyboard according to another preferred embodiment of the present invention, wherein the peripheral keyboard is in the shape of a predeterminedly very thin line extending around unoccupied sides of the display, and wherein the very thin line keyboard is separated into four parts not connected to each other.

FIG. 13 illustrates a schematic view of the proposed device showing a predeterminedly thin and elongated screen image according to another preferred embodiment of the present invention, wherein the image appears on the screen and extends along and around the sides of the screen and is used to display advertisement images and/or messages.

### DETAIL DESCRIPTION OF PREFERRED EMBODIMENTS OF THE INVENTION

While the invention may be susceptible to embodiment in different forms, there are shown in the drawings, and will be described in detail herein, specific embodiments of the instant invention, with the understanding that the present disclosure is to be considered an exemplification of the principles of the invention, and is not intended to limit the invention to that as illustrated and described herein.

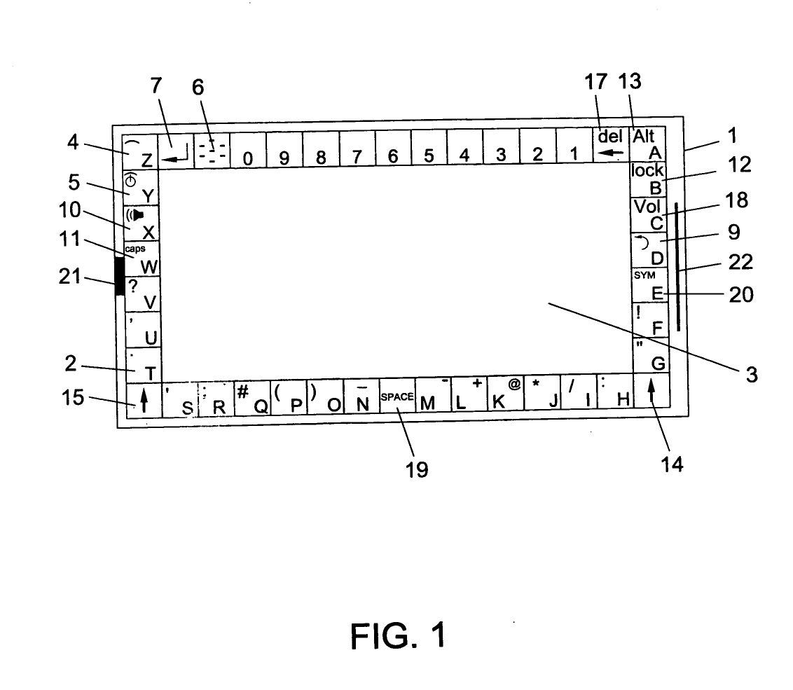

Referring to FIG. 1, there is shown an electronic processing device, preferably a mobile telecommunication device (1), preferably shaped as a rectangular parallelepiped, which device (1) has: a display (3) (or screen), preferably of a rectangular shape; the device (1) has a face side accommodating an alphanumerical keyboard device (2) that extends around (and/or on, and/or along) at least a substantial portion of the four sides of the display (3). Therefore, the keyboard (2) preferably has a shape of a rectangular frame or a portion thereof. Therefore, in general, according to the invention, the inventive processing device has a face side, and the device comprises a display unit and a keyboard, wherein the keyboard peripherally extends around at least a portion of the display.

More specifically, the keyboard is preferably an alphanumerical keyboard, the display unit has a rectangular shape having a perimeter with two longitudinal and two transversal sides, and the keyboard extends around at least a portion of the perimeter. Also, in general, it can be noticed that the display has a predetermined perimeter, and the alphanumerical keyboard extends around at least a portion of the perimeter.

Furthermore, the inventive device may have a microphone (21), a speaker (or ear piece) (22), and the alphanumerical keyboard of the device may extend at least around a substantial portion of one longitudinal side and of two transversal sides of the display of the device, in order to conveniently enter data, when the device is held horizontally in a landscape mode, with the speaker located on one transversal side and the microphone located on the other transversal side.

It should be noted that even if the following preferred embodiments mostly refer to alphanumerical frame shaped keyboards and/or keyboard locators (further described herein), all of the ideas developed in this patent application should be applicable also to alphabetical, and/or numerical, and/or any other types of frame shaped keyboards and/or keyboard locators, for both image ones and/or hardware ones. Moreover, it should be also noted that this patent application and all its specifications do not apply only to peripheral keyboards or keyboard locators comprising English or European speaking alphabetical characters. Indeed, the keyboards or keyboard locators (and their respective ambiguous and/or unambiguous keys) described in this patent application can also be understood as comprising any type of non-European foreign alphabet characters and/or symbols. The term ‘alphabetical character’ used in this patent application should be understood (when necessary) as including also other characters and/or symbols of foreign alphabets and/or languages such as for example (list not limitative): Chinese, Indian, Japanese, Arabic, Hebrew, Russian, Korean.

The frame shape of the alphanumerical keyboard (2) results from the rectangular arrangement of the keyboard around at least a substantial portion of the four sides of the display (3).

The frame shape arrangement of the keyboard (2) can also possibly result from the combination or assemblage of several types of individual keyboards extending on and/or around at least a substantial portion of the frame of the display (3), and/or around at least a substantial portion of the sides of the display itself. Examples of individual keyboards are: alphanumerical keyboard, numerical keyboard, alphabetical keyboard, command keyboard, symbol keyboard, and so forth.

As shown in FIG. 1, the keyboard (2) extends around at least a substantial portion of the four sides of the display (3), in such a way that the keyboard (2) takes a minimal space from the display (3) on the face side of the device (1), allowing the device (1) to have the largest display (3) possible on its face side, and still with a full alphanumerical keyboard (2).

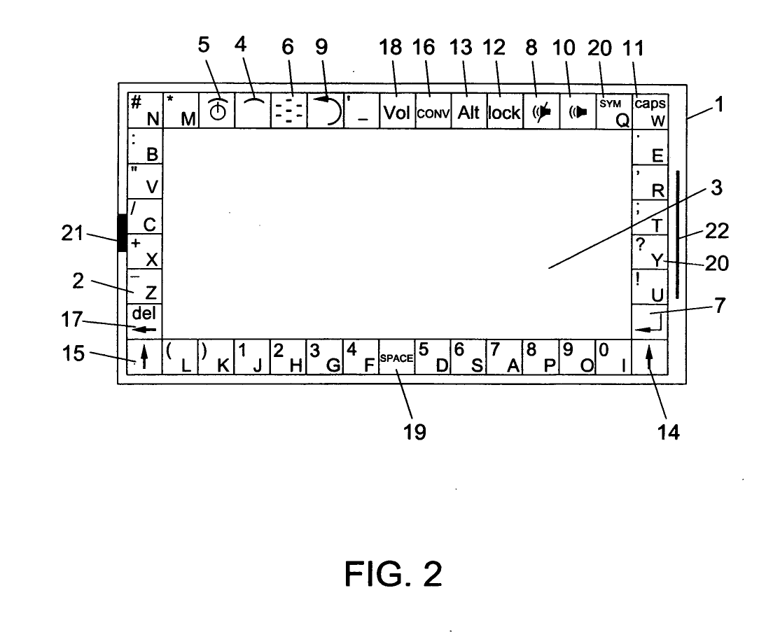

The inventive device illustrated on FIG. 2 preferably comprises a microphone (21) located on one end of the face side of the device, and a speaker (ear piece) (22) located on the other end of the face side. The display (3) extends from the area located in the vicinity of the microphone to the area located in the vicinity of the ear piece, and wherein the alphanumerical keyboard and its alphanumerical keys extend around at least a substantial portion of at least three sides of the display, and wherein consequently the alphanumerical keys of the keyboard have substantially large dimensions as a result of the alphanumerical keys placed around the extended display on the face side of the device.

The following options are provided for the keyboard (2):

a) The alphanumerical keyboard (2) is represented by an image keyboard appearing on the display, said image keyboard having image keys; or
b) The device (1) comprises a hardware frame, and the alphanumerical keyboard (2) is made as a hardware keyboard extending on the frame, said hardware keyboard having hardware keys; or
c) The alphanumerical keyboard (2) is represented by a combination of the image keys and the hardware keys.

Moreover, the alphanumerical keyboard (2) of the option (a) is at least a digital touch screen data entry keyboard, and/or the alphanumerical keyboard (2) of the option (b) is at least a mechanical “push down” data entry keyboard, and/or the alphanumerical keyboard (2) of the option (c) is a combination of the digital touch screen data entry keyboard and/or a combination of the mechanical “push down” data entry keyboard.

As shown in FIG. 2, the keys of the keyboard (2) can follow a continuous mobile Qwerty keyboard arrangement, around at least a substantial portion of the four sides of the display (3). However, as shown in FIG. 1, the keyboard (2), as a preferred embodiment, follows a regular alphabetical and numerical arrangement.

It should be noted that the alphanumerical keyboard (2) expending around at least a substantial portion of the display (3) also comprises keys having at least one of the following characters: numerical characters, command characters, and symbol characters like, as a preferred embodiment, the “Send” key (4), the “End/Power” key (5), the “Menu” key (6), the “Enter” key (7), the “Mute” key (8), the “Escape” key (9), the “Speaker Phone” key (10), the “Caps” key (11), the “Lock” key (12), the “Alt” key (13), the right “Shift” key (14), the left “Shift” key (15), the “Convenience” key (16), the “Backspace/Delete” key (17), the “Volume” key (18), the “Space” key (19), the “symbol” key (20).

In preferred embodiments, the device comprises a predetermined number of software applications. The alphanumerical keyboard comprises a number of keys associated with at least one application of said predetermined number of software applications. The alphanumerical keyboard (and/or alphanumerical keyboard locator) comprises other possible keys (and/or commands and/or characters and/or symbols and/or any other type of data) that are relevant, relating to or useful for a particular software application that the user is using on its mobile telecommunication device (not illustrated). Some example of these popular software applications are: phone calls applications, emails, messages, internet, navigation/maps, music, video, video recording/camera, instant messaging, video games, software applications for office works like Microsoft Office Word®, Microsoft Office Excel®, Microsoft Office Power Point®, Microsoft Office Outlook®, and so forth.

As an example, if the user is using a media player application, the image of the alphanumerical keyboard (and as shown further on, the image of the keyboard locator) shows additional, and/or others, keys and/or commands like the “Play” key, the “Stop”, the “Fast Forward” key, the “Search” key or bar, and so forth. As another example, if the user is using the Microsoft Word application, the image of the alphanumerical keyboard (and/or the image of the alphanumerical keyboard locator) shows additional, and/or other, keys and/or commands like the “File” key, the “Edit” key, the “View” key, the “Insert” key, and so forth.

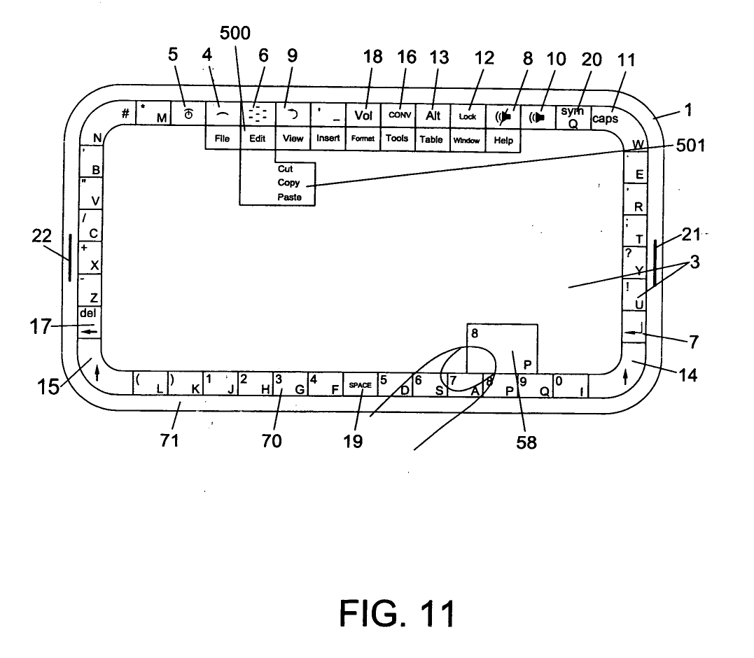

In a preferred embodiment, as depicted on FIG. 11, if the user selects (by any possible technical means) the “Edit” key (500) appearing on a second row (on one side of the display) of the image keyboard locator (70), consequently, the selection is preferably followed by the opening of the image of a window application (501) relating to the key (500) in which the “Cut”, “Copy” and “Paste” commands preferably appears. The image of the type of window application (501) preferably opens, and/or appears, (as it is the case generally for every computer) under the image of the main key (500), and/or command it belongs to.

This is particularly possible in the instance of the rectangular frame-shaped keyboard, and/or keyboard locator, because these keyboards, by their particular shape, allow the center part of the display to be open and free to support additional images. In fact, it is important to remember that the frame shaped alphanumerical keyboard (and/or frame shaped alphanumerical keyboard locator) of this invention, and in particular their images on the display, have different possible configurations depending on a particular type of application the user is using, and depending on what keys/characters/commands/symbols/data are relevant to be shown to the user based on the software application used.

As an example, the frame shaped keyboard locator of this invention (preferably its image on the display) could have more than one row of keys on at least one side of the display of the device (see FIG. 11), in order to carry all the relevant keys useful to the good use of the various software applications of the device. Moreover, if at least one side of the device has at least two rows of keys (keys belonging preferably to an image keyboard and/or to an image keyboard locator), then at least one of these rows preferably has a different data entry system, and/or apparatus, from the other row.

For example, if one side of the device has two rows of image keys, then one row of these image keys preferably answer to a one “click” or one “touch” data entry system and apparatus, while the image keys of the other row are preferably activated by a double “click” or double “touch” data entry system and apparatus.

As shown, e.g. on FIG. 1 or 2, the device (1) has a microphone apparatus (21) and an earring apparatus (speaker) (22) in order to perform a phone conversation. It should be noted that the mobile telecommunication device of the invention can be at least: a telephone apparatus, and/or a computer, and/or a media player, and/or a navigation device, and/or a video game device, and/or any other type of mobile telecommunication device. It is also very important, that all the new ideas of this patent application apply to any type of mobile electronic devices, even those that do not necessarily telecommunicate. Please note also, and this is very important, that all the new ideas of this patent application apply also to any type of electronic devices, even those that are not wireless and/or mobile. The ideas of this patent application apply to mobile telecommunication devices as a preferred embodiment.

The display (3) of the inventive device is preferably a display working with at least a touch sensitive data input system and/or apparatus.

Two preferred arrangements of the frame shaped keyboard (2) are described below:
First, as seen in FIG. 1, the numerical keys (or numerical keyboard), in a preferred embodiment, are located on at least a substantial portion of at least one of the four sides of the device in preferably such a location as to allow the thumb of the user's holding hand to reach them easily, especially when the user is dialing a phone call using the same hand (to hold the phone and to dial the phone number).

In this instance, the alphabetical keys (or alphabetical keyboard) are preferably located on at least a substantial portion of at least the three other sides in a way that they are easily accessible to both thumbs of the user's hands when he uses the telecommunication device in a text message position (i.e. when the user is using the telecommunication device with both hands in a horizontal/landscape position).

In fact, as seen in FIG. 1, the numerical keys (or numerical keyboard) extends at least on a substantial portion of at least one side of the device, and the alphabetical keys (or alphabetical keyboard) extend at least on a substantial portion of at least three other sides of the device.

Moreover, as seen in FIG. 1, the numerical keys (or numerical keyboard) are preferably located in a different location from the alphabetical keys (or alphabetical keyboard) around the display (3).
Second, in the other preferred embodiment, shown in FIG. 2, at least a substantial portion of at least three of the sides of the device (1) have alphanumerical keys (or an alphanumeric keyboard) and at least a substantial portion of the fourth side of the device (1) has various command and/or symbol keys (or command and/or symbol keyboard). Moreover, one can notice that the alphanumerical keys (or alphanumerical keyboard) are unambiguous since they comprise only one alphabetical character per key.

In this instance, the alphanumerical keys (or alphanumerical keyboard) are preferably located in their majority (and especially the keys to which numbers are assigned) on at least a substantial portion of the side surface of the device (1) that allows the thumb of the user's holding hand to reach them easily, especially when the user is dialing a phone call using the same hand (to hold the phone and to dial the phone number). Preferably, the alphanumerical keys (or alphanumerical keyboard) are located on the left side of the device (1) when the device is facing the user and is being held in a vertical position during a phone call. The keys having numbers are preferably aligned next to each other on the alphanumerical keyboard (2).

The keys with numbers are preferably aligned along the longitudinal side of the display. Preferably, the alphanumerical keys are located on at least a substantial portion of at least three sides (one longitudinal side and two transversal sides) in a way that they are easily accessible to both thumbs of the user's hands, i.e. when the user is using the telecommunication device with both hands in a horizontal/landscape position (e.g. during sending/receiving text messages). Preferably, the device has a speaker (ear piece) (22) located on one transversal side and a microphone (21) located on the other transversal side.

It is a well known fact that a conventional unambiguous Qwerty keyboard is usually made of three rows of alphabetical keys, and that each of the keys have one alphabetical character per key. One can imagine that at least one of the three alphabetical rows (and/or at least a segment of at least one of the three alphabetical rows) can be assigned to at least one specific side (and/or assigned to at least a segment of at least one specific side) of the device (1). This particular method for arranging the conventional unambiguous Qwerty keyboard around the display (3) of the device (1) is useful to the user because it is an organized, logical and understandable one for the user. Indeed, the user is able to easily locate the Qwerty keyboard keys around the display (3) because the purpose of the method is to keep the arrangement of the unambiguous Qwerty keyboard around the display as close as (or as identical as) possible to the conventional “three rows” unambiguous Qwerty keyboard arrangement. In fact, as a preferred embodiment, some full alphabetical rows of keys located on and/or around the sides of the display (3) of the device (1) are preferably identical to the ones of the conventional unambiguous Qwerty keyboard. For example, as a preferred embodiment only, one can imagine that the top row of a conventional “three rows” unambiguous Qwerty keyboard (the top row having the ten unambiguous alphabetical keys Q, W, E, R, T, Y, U, I, O and P) is assigned to the top longitudinal side of the device (1).

In a variation of the same example, the bottom row of the conventional keyboard (the bottom row having seven unambiguous alphabetical keys Z, X, C, V, B, N and M) is preferably assigned to the bottom longitudinal side of the device (1). Still in the same example, the middle (or second) row of the conventional keyboard (the middle row having the nine unambiguous alphabetical keys A, S, D, F, G, H, J, K and L) is preferably divided into two segments “A, S, D, F, G” and “H, J, K, L”, and each one of the two segments is assigned specifically to one of the two transversal sides of the device (1) (with “A, S, D, F, G” assigned preferably to the left side and “H, J, K, L” assigned preferably to the right side of the device (1) when the device (1) is held in a landscape position).

In another example, each one of the three previous unambiguous alphabetical rows of a conventional Qwerty keyboard (the top one, the middle or second one, and the bottom one) is entirely assigned to a specific side of the device (1) (with preferably one entire specific unambiguous alphabetical row of the conventional Qwerty keyboard assigned per side around the display (3). This particular method of arrangement of a conventional unambiguous Qwerty keyboard around the display (3) is applicable to any type of frame shaped keyboards (and/or frame shaped keyboard locators) described in this patent application.

For example, the arrangement can be applicable to frame shaped hardware (and/or mechanical) keyboards located preferably on and/or around the hardware frame of the device (1), but it can also be applicable to frame shaped image keyboards (and/or frame shaped image keyboard locators) appearing on and/or around the display (3) of the device (1). Other organized and logical methods of arrangement of the unambiguous alphabetical keys on and/or around the display (3) of the device (1) are also possible.

For example, as shown in FIG. 2, the unambiguous alphabetical keys of the keyboard (2) follow one after the other (preferably in a ‘one row’ or linear manner) that herein is called a “continuous” Qwerty arrangement of a conventional unambiguous Qwerty keyboard on/and around and/or along at least one side of the display (3). It is called a “continuous” Qwerty arrangement because the arrangement makes the alphabetical keys of an unambiguous conventional Qwerty keyboard follow each other on and/or around preferably at least three sides of the display (3) based on the principle that one reads the unambiguous ‘three rows’ conventional Qwerty keyboard in a continuous manner preferably from left to right and preferably starting from the top row. Another logical method for arranging the unambiguous alphabetical keys on and/or around the display (3) is for these keys to follow one after the other (preferably in a ‘one row’ or linear manner) a basic alphabetical order on (and/or around and/or along) at least a substantial portion of one side, or two sides, or three sides, or four sides of the display (3) of the device (1) as shown in FIG. 1.

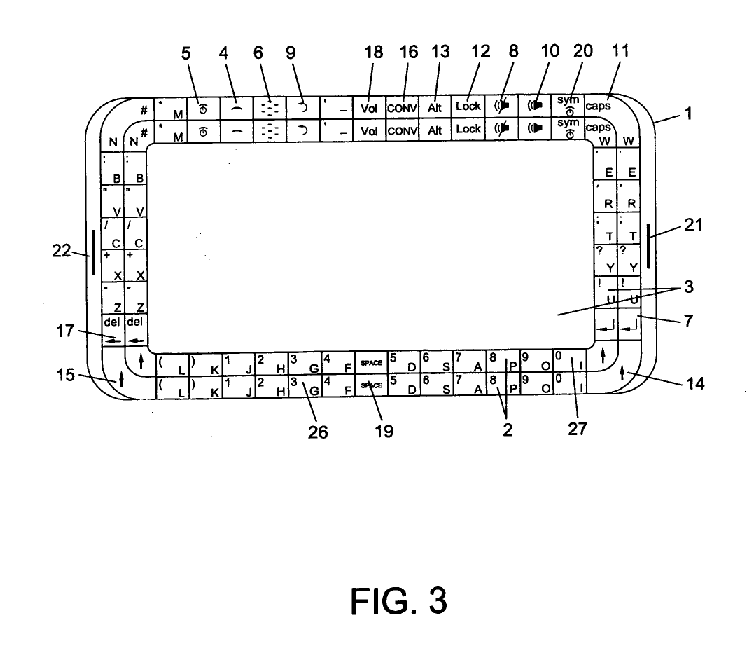

An embodiment of the inventive data entry apparatus of a new type, derived at least in part from the various aforementioned ideas, is described below. This embodiment of the keyboard (2) is shown in FIG. 3 of this application.

It can be said that the keyboard device (2) comprises two keyboard units (e.g., as illustrated on FIG. 3):
a keyboard locator (26) preferably situated on the hardware frame of the mobile telecommunication device (1). In general, in this patent application, the keyboard locator (that should also be considered as a key locator, and/or a character locator, and/or a symbol locator, and/or a command locator, and/or a data locator in general) can be situated not only on the hardware frame of the device, but also as an image on and/or around the display of the mobile telecommunication device. In fact, this description of keyboard (2) is also applicable if the keyboard locator (26) is a screen image located on and/or around the display (3).
a keyboard unit (27), which is an image representation of a common mechanical keyboard on the display (3) of the mobile telecommunication device (1), having preferably at least a touch sensitive data entry system and/or apparatus.

Therefore, the keyboard locator (26) is preferably a 2D (digital image keyboard and/or its digital image un-functional/inactive imitation) appearing on the display (3), or a 3D (real physical hardware keyboard and/or its physical un-functional/inactive imitation) full alphanumerical keyboard, which extends preferably around at least a substantial portion of at least three sides of the display (3) of the device (1). Preferably, the keyboard locator (26) has a set of keys corresponding exactly (or at least substantially) to the set of keys of the keyboard unit (27).

The keyboard (27) is also a full alphanumeric keyboard. The keyboard (27) has its keys and/or characters/commands/symbol/data arranged (at least for most of them) in the same order than the keys and/or characters/commands/symbol/data of the keyboard locator (26). The keyboard (27) extends also (at least substantially) in the same manner and order as the keyboard (26) around at least a substantial portion of the sides of the display (3) of the device (1), in such a way that at least most of the same keys of both keyboards are preferably next to each other. In fact, one could say that the keyboard locator (26) is (at least substantially) a copy of the keyboard unit (27) of the display (3).

In a preferred embodiment, the keyboard unit (27) of the display (3) is not visible to the user when the user is entering data in its mobile telecommunication device (1) through this keyboard unit (27).

In fact, the user knows where the keys and/or characters/commands/symbols/data of the keyboard unit (27) (having preferably at least a touch sensitive data entry system and/or apparatus) are located by looking at the location of the keys and/or characters/commands/symbols/data of the keyboard locator (26) preferably situated on a predeterminedly thin hardware frame of the mobile telecommunication device (1).

Consequently, in this particular data entry system, the main purpose of the keyboard locator (26) is to show to the user where the invisible keys (and/or characters/commands/symbols/data) of the keyboard unit (27) are located on and/or around at least a substantial portion of the edges and/or sides of the display (3). Consequently, the keyboard locator unit (26) extends also around at least a portion of the perimeter of said display.

In fact, the alphanumerical keyboard (27) has a predetermined keyboard set of keys, and the device (1) further comprises a keyboard locator unit (26) having a locator set of keys corresponding to said predetermined keyboard set of keys, the keys of said locator set of keys are disposed in a manner to indicate the locations of the keys of said predetermined keyboard set of keys.

The keyboard locator (26) is preferably, in this particular instance, not necessarily made to be an active keyboard through which data is entered in the telecommunication device (1). Its main purpose is to help the user to locate the location of the keys (and/or characters/commands/symbols/data) of the invisible and/or display (and preferably touch sensitive) keyboard (27). It could be said that the keyboard locator (either hardware and/or image one) is a representation of an invisible keyboard located on the display. In fact, the keyboard locator (26) is preferably more a key (and/or characters/commands/symbols/data) locator of the keyboard (27) than a keyboard per se (but the keyboard locator (26) could also operate as a fully active keyboard).

It could also be said that the alphanumerical keyboard (27) is a visual representation of a predetermined set of keys located within a predetermined space allocated on the display (3), and that said keyboard predetermined set of keys consists of keys invisible to the user, and that the keyboard locator unit (26) is situated on the face side of the device (1), and that said keyboard locator unit (26) is arranged as a representation of said alphanumerical keyboard (27) in order to indicate to the user the exact location of the invisible keys of said keyboard predetermined set of keys on and around said display.

Optionally, at least some of the keys of the keyboard locator (26) might be active data entry keys either in the case of a keyboard locator located on and/or around the hardware frame of the device, and/or in the case of an image keyboard locator appearing on and/or around the display of the device. For example, as shown in FIG. 3, at least some of the keys of the keyboard locator (26) can be used to input data using any type of data entry system and/or apparatus like (but not limited to) a mechanical “push” and/or “click” data entry system.

In fact, in the particular preferred embodiment of FIG. 3, the image and/or preferably touch screen keyboard (27) is preferably the active keyboard unit through which the data are effectively entered by the user.

Indeed, since, in the preferred embodiment of FIG. 3), the frame of the display (3) is predeterminedly thin and low, then, when the user touches a key on the frame, the user touches automatically the corresponding (preferably touch sensitive) key on the invisible and/or display keyboard (27), and the user then consequently enters the data assigned to the key. It should however be noted that the keyboard (27) can be activated as a result of any type of action of the user on the keyboard locator (26), and/or as a result of any other system and/or apparatus of data input interactivity technique between the keyboard locator (26) and the keyboard (27).

The purpose of this particular keyboard (2) is to create the thinnest and least cumbersome possible full alphanumerical data entry apparatus together with the largest possible display for a mobile telecommunication device (and at lowest possible manufacturing cost). In actual mobile telecommunication devices, keyboards are either hardware ones and/or an image ones. Actual conventional keyboards are spreading on at least a substantial portion of the center part of the face side of the device and its display. For example, an actual and regular image keyboard usually occupies at least half of space on the display, so much that a software application used by the user cannot be visible anymore when the user is using this regular image keyboard. Herein, the frame keyboard, and especially the frame keyboard locator, while being in use, still potentially allow the images of any software application to be fully (if not at least substantially) visible, and this because of their particular shape which leaves the center part of the face side (and its display) open and free for any other software application images.

In a general manner, FIG. 3 should also be considered as showing a hardware (i.e. mechanical) keyboard (26) that has preferably a predeterminedly thin, elongated, and/or linear, and/or non-invasive, one row shape. This particularly shaped keyboard (26) is preferably located (at least for a substantial part of it) along (and/or around) at least a substantial (and/or major portion) of the edges of the interface of the device (1), preferably in order to allow the display (3) to substantially expand in dimensions on the interface of the device (1). The display (3) preferably extends on all the surface of the interface preferably up to the limits defined by the thin and elongated keyboard (26) and/or the frame it is located on. As a result of this expanded display (3), the thin and elongated keyboard (26) preferably extends (at least for a substantial part of it) along (and/or around) at least a substantial (and/or major portion) of the edges of the interface of the device (1) but also at the same time preferably extends (at least for a substantial part of it) along (and/or around) at least a substantial (and/or major portion) of the edges of the display (3).

The above described hardware and/or software parts of the keyboard (2) can be easily installed and/or downloaded on any mobile telecommunication device having a large display (example: iPhone® of Apple Inc.®).

It also should be noted that if the mobile telecommunication device has an additional protective cover installed around its frame, then the keyboard locator (and/or the frame keyboard) can be replicated on the frame of the protective cover around the display.

The alphanumerical keyboard (and/or alphanumerical keyboard locator), and all their preferred embodiments described above, have preferably unambiguous keys comprising only one alphabetical character per key and entering unambiguous characters preferably with character by character data entry system.

However, the alphanumerical keyboard (and/or alphanumerical keyboard locator) can also have ambiguous keys working preferably at least with a predictive data entry system, in order for the user to avoid typing all the letters of common words until the end of them, and/or in order to avoid any possible mistyping of these common words by the user. These ambiguous keys comprise at least two alphabetical characters per key, and enter ambiguous characters.

In the case of a frame keyboard, and/or in particular in the case of a frame keyboard locator, having at least a two row configuration on at least one side of the display of the device, one can imagine that one row carries ambiguous keys, and that the other row carries unambiguous keys, and that one row preferably works with a different data entry system and/or apparatus than the other row. For example, one row of an image frame keyboard locator having keys to which are assigned only one alphabetical character per key (unambiguous keys) works with a double “click” or double “touch” data entry system, while the other row of the image keyboard locator having keys to which are assigned at least two alphabetical characters per keys (ambiguous keys) works with a one “click” or one “touch” data entry system. In this last example, the row of the unambiguous keys corrects, and/or adds, to the characters entered with the one “touch” row of the ambiguous keys.

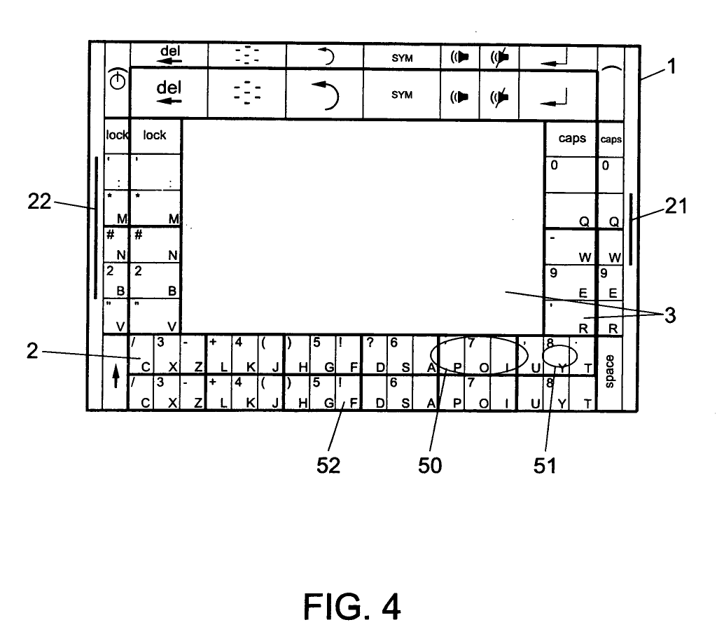

As shown in the preferred embodiment of FIG. 4, the particular keyboard (2) of the instance is made of several ambiguous keys (preferably large in size), e.g. a key (50). Most of the ambiguous keys of the keyboard (2) have preferably assigned to each one of them at least one numerical character, preferably several alphabetical characters, and preferably at least one symbol and/or command character.

The keyboard (2) can also be divided, at least in part, into unambiguous keys (preferably of a predeterminedly small size), like the key (51). At least most of the unambiguous keys are preferably located on a specific location next to, and/or inside, the location of their respective ambiguous key. To each unambiguous key is assigned one alphabetical character and/or at least one numerical, and/or symbol, and/or command character preferably also assigned to its respective ambiguous key.

The question is: how can the user enter any character and/or data he wants, using this preferred embodiment of the keyboard (2)? The answer is: through the combination of the ambiguous (and/or preferably predictive) data input system and/or apparatus of the ambiguous keys, and through the unambiguous (and/or preferably character by character) data input system (and/or apparatus) of the unambiguous keys.

Preferably as a first step, the user enters any character (and/or any other type of data) using the ambiguous keys of the keyboard (2) to which are assigned the characters (and/or data) he wishes to enter. When the user uses these ambiguous keys, he is entering words (and/or any other type of data) preferably through a conventional ambiguous (and/or preferably word predictive) data entry software system.

Most of the words that the user enters are usually common words that the ambiguous (and/or preferably word predictive) software system has recorded in its memory. If the user has to enter a word (and/or any other type of data) that is not in the memory, and/or if the user has to correct a word (and/or any other type of data) entered, the user then preferably uses the unambiguous keys and their unambiguous (and/or preferably character by character) data entry system and/or apparatus, preferably as a second step. The user preferably does so by selecting through any possible technical means (like for example, but not limited to, pushing, and/or pressing, and/or clicking, and/or touching, and so forth) any area on the device (1) (in the FIG. 4, the area is preferably located on the display (3)) that is specifically assigned to an unambiguous key having a data he wishes to input unambiguously (and/or preferably character by character).

It is important to note the following points:

First: the various keyboard (2) described in the application can be made at least in part of hardware mechanical keys (preferably located on the frame of the device (1)), and/or can be made at least in part of image (and/or digital, and/or touch screen) keys having at least a touch sensitive data input system (preferably located on the display (3)).

Second: the various keyboard (2) described in the application can be made at least in part of a hardware mechanical keyboard (preferably located on the frame of the device (1)), and/or can be made at least in part of an image (and/or digital, and/or touch screen) keyboard having at least a touch sensitive data input system (preferably located on the display (3)).

Third: the ambiguous keys described previously can be keys having at least a mechanical, and/or digital touch sensitive data input system and/or apparatus, and the unambiguous keys described previously can be keys having at least a mechanical, and/or digital touch sensitive data input system and/or apparatus.

If the user uses ambiguous mechanical keys (preferably located on the hardware frame of the device (1)) to input data through an ambiguous (and/or preferably predictive) data input system, then preferably, the unambiguous (and/or preferably character by character) data entry system is done through the unambiguous image (and/or digital, and/or touch screen) keys located preferably on the display (3) and having preferably at least a touch sensitive data input system and/or apparatus, and whose location the user knows because they are indicated preferably on the hardware of the ambiguous mechanical keys. In fact, the hardware of the mechanical keys acts also as a keyboard locator of the preferably invisible keys located on the display (3) and having preferably at least a digital touch sensitive data input system and/or apparatus. But please note also that possibly the unambiguous (and/or preferably character by character) data input system could be done using unambiguous mechanical keys located preferably on and/or around the hardware frame of the device (1).

If the user uses ambiguous image (and/or digital, and/or touch screen) keys (located on and/or around the display (3)) to enter words (and/or any other type of data) through an ambiguous (and/or preferably predictive) data entry system and/or apparatus having preferably at least a touch sensitive data entry system, then preferably the unambiguous (and/or preferably character by character) data entry is done using either the unambiguous preferably at least touch sensitive digital keys (located on and/or around the display (3)), and/or ambiguous and/or unambiguous mechanical keys of the keyboard (2) (located preferably on and/or around the frame of the device (1)).

If the user uses ambiguous image (and/or digital, and/or touch screen) keys having preferably at least a touch sensitive ambiguous (and/or preferably predictive) data entry system and/or apparatus, and/or unambiguous image (and/or digital, and/or touch screen) keys having preferably at least a touch sensitive unambiguous (and/or preferably character by character) data entry system and/or apparatus, these ambiguous and/or unambiguous keys of the image (and/or digital, and/or touch screen) keyboard (2) are preferably invisible to the user and do not appear on the display (3).

However, the user knows where these keys are located preferably through the mechanical keyboard locator, and/or keyboard locator (52), located on the frame of the device (1). In this particular instance, these ambiguous and/or unambiguous keys have preferably at least a touch sensitive data entry system and/or apparatus. Indeed, either, and/or both, of these ambiguous and/or unambiguous keys can be equipped with another, and/or additional, data entry system and/or apparatus.

For example, the ambiguous keys can be equipped with a touch sensitive data entry system and/or apparatus, while the unambiguous keys can be equipped with a touch sensitive, and/or “click”, data entry system and/or apparatus. As a preferred embodiment, the keys working with an ambiguous (and/or preferably predictive) data entry system have preferably a touch sensitive data input system and/or apparatus, while the keys working with an unambiguous (and/or preferably character by character) data entry system have preferably a touch sensitive, and/or “click”, data entry system and/or apparatus (but the opposite is also possible).

At this stage of the description, a few more details should be added:

1* The keyboard (2) is made preferably of at least four ambiguous keys of a predeterminedly large size and working preferably with an ambiguous (and/or preferably predictive) data entry system and/or apparatus.

2* Any character, and/or command, and/or symbol, and/or data, can be assigned to (and/or divided between) any ambiguous and/or unambiguous key, in a predetermined specific arrangement, in order to make the ambiguous (and/or preferably predictive) data input system work with more accuracy.

3* The ambiguous keys of the keyboard (2) are predeterminedly large in dimensions and can extend on at least substantial portions of three sides or four sides of the device (1).

4* Making the ambiguous keys of predeterminedly large dimensions and working with ambiguous (and/or preferably predictive) data input systems allows to avoid mistyping problems (especially for common words), especially on a digital touch sensitive keyboard.

5* The word predictive system is preferably a conventional one with memory software and/or hardware apparatus, which compiles preferably all common words, and/or words entered by the user in the memory of the device (1) after typing them on the device.

6* Generally, the keyboard (2) extends on a substantial portion of the four corners of the device (1).

7* Generally, any type of key and/or any type of keyboard described in this application can have any possible type of data entry system and/or apparatus (for example, but not limited to): a mechanical data entry system and/or apparatus; a touch sensitive data entry system and/or apparatus; and so forth).

8* It should be noted that the ambiguous keys (preferably large in dimensions) of the keyboard (2) can form together a full mobile alphanumeric keyboard.

9* When the user selects an ambiguous key, he does so by preferably touching (and/or clicking, and/or pressing, and/or selecting by any other means) the location specifically assigned to the ambiguous key on the surface of the display (3), and/or on any other specific location on the device (1).

10* In this application, the unambiguous keys can also additionally work in combination with an ambiguous (and/or preferably word predictive) data input system.

11* The unambiguous (and/or preferably character by character) data input system is a good tool in order to guide the ambiguous (and/or preferably predictive) data input system in the case where the typing of one word with the ambiguous (and/or preferably predictive) system comes out with several possible word choices. By entering, and/or correcting, precisely with the unambiguous (and/or preferably character by character) data entry system at least one letter of the word typed with the ambiguous (and/or predictive) system, the ambiguous (and/or predictive) system is then able to determine what is exactly the one and only possible word the user wishes to enter.

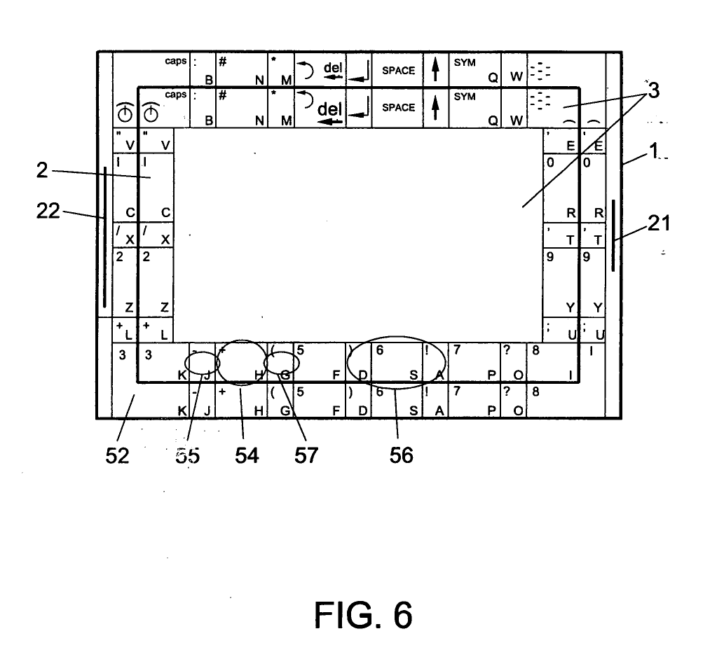

12* In this application, a key working with an ambiguous (and/or preferably predictive) data input system is preferably considered to be either any key (at least image and/or hardware one) to which at least two alphanumerical characters are assigned to (please see example of key (50) of FIG. 4), and/or either a key (at least image and/or hardware one) which is the result of any possible structural arrangement of at least two keys preferably located next to each other on the display (3) and having, each one of them, at least one alphanumerical character (please see example of key (56) of FIG. 6, which comes from the combination of two narrow keys and one large key). Any particular structural arrangement is preferably represented on the keyboard locator (52), located preferably (but not necessarily) on the hardware frame of the device (1), around at least substantial portions of three and/or four sides of the device.

13* As shown in the preferred embodiment of FIG. 4, some keys located on the hardware frame (and/or on the keyboard locator (52)) of the device (1) can be hardware and/or mechanical keys which do not have a respective key represented on the display (3), like for example the “Space” key, the “Shift” key, the “End/Power” key and the “Send” key.

At least one ambiguous key (50) (preferably of large dimensions), and/or at least one unambiguous key (51) (preferably of small dimensions), and/or at least part of the data assigned to the unambiguous and/or ambiguous keys, can be assigned (and/or included) to at least one ambiguous key (200) (preferably of larger dimensions) located on the device (1).

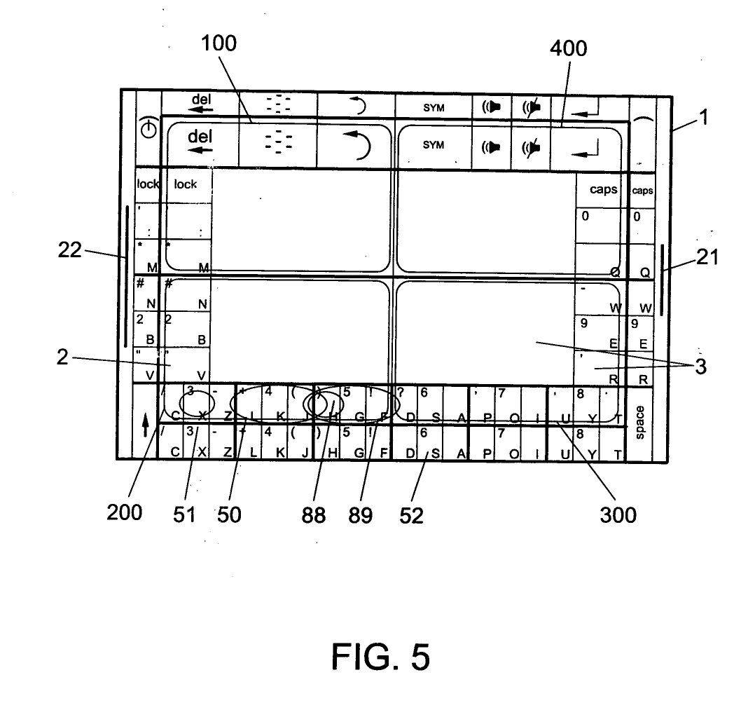

As shown in the preferred embodiment of FIG. 5, the device (1) has at least one keyboard (2), the keyboard (2) being in the preferred embodiment a digital one appearing on the display (3). The keyboard (2) is extending around at least a substantial portion of the three sides or four sides of the device (1). The keyboard (2) is made of unambiguous (predeterminedly small size) keys (like the key (51) for example), and/or ambiguous (preferably large) keys (like key (50) for example), and/or ambiguous (preferably larger) keys like keys (100), (200), (300), (400).

The data input system of the keyboard operates as follows: Preferably, the user enters data using the ambiguous (preferably larger) keys. Like ambiguous (preferably large) keys, these ambiguous (preferably larger) keys work with an ambiguous (and/or preferably word predictive) data input system. The user selects (by any possible means) these ambiguous (preferably larger) and comfortable keys to enter common words and/or other words included in the software memory of the device (1).

In most instances, whenever there is a case of several possible choices of words, and/or a case of a correction of an input, and/or any other case of unambiguous (and/or non-predictive) data entry system of a word and/or data, the user enters data using the ambiguous (predeterminedly large) keys and/or the unambiguous (preferably small) keys. The ambiguous (predeterminedly larger) keys, and/or the ambiguous (predeterminedly large) keys, and/or the unambiguous (predeterminedly small) keys are preferably image (and/or digital, and/or touch screen) keys appearing on the display (3), which work essentially with a touch sensitive data entry system and/or apparatus. The architecture of these keys is structured (and/or organized) preferably by the software of the device (1) on the display (3). At least one of these types of keys (small, large, and/or larger) could also preferably be hardware mechanical keys.

The four ambiguous (predeterminedly larger) keys of the keyboard (2) expand on at least a substantial part of the surface of the display (3) of the device (1). The image (and/or digital, and/or touch screen) keys having preferably at least a touch sensitive data entry system (unambiguous preferably small keys, ambiguous preferably large keys, and ambiguous predeterminedly larger keys) are preferably invisible to the user on the display (3) when he uses them. As said before, the user knows the location of the keys by looking at a key locator (52) located preferably (but not necessarily) on and/or around the hardware frame of the display (3). Noticeably, such keyboard/key/character/symbol/data locator, herein called ‘keyboard locator’, can be situated, and/or appear, not only on the hardware frame of the device, but also as an image on and around the display of the mobile telecommunication device. In fact, this description of keyboard (2) is also applicable if the keyboard locator is an image one located on and/or around the display (3). The keyboard locator (52) indicates the location of the ambiguous (preferably larger), and/or the ambiguous (preferably large), and/or the unambiguous (preferably small) keys on the display (3).

As illustrated on FIG. 5 and shown above, the ambiguous (and/or predictive) data entry system and/or apparatus of the ambiguous (preferably larger) keys is used preferably, as a first step, to enter common words and/or recorded words. Then, the unambiguous (and/or preferably the ‘character-by-character’) data entry/apparatus of the unambiguous (predeterminedly small) keys, and/or the ambiguous (predeterminedly large) keys, is used preferably, as a second step, to correct and/or help select the common words entered with the ambiguous (predeterminedly larger) keys, and/or is used to enter words that are not common or recorded in the memory of the device (1).

The alphanumerical keyboard of the device (1) of the FIG. 5 comprises four ambiguous (predeterminedly larger) keys, respectively keys (100), (200), (300) and (400).

Several unambiguous (and/or preferably character by character) keys are assigned to (and/or are part of) each one of these ambiguous (preferably larger) keys. For example, the unambiguous (predeterminedly small) keys “D/?”; “S/6”; “A”; “P/;”; “O/7”; “I”; “U/,”; “Y/8”; “T/.”; “'/R”; “E/9”; “W/”; “0” and “caps” are assigned to the ambiguous key (300). One can also notice that several unambiguous keys can be possibly combined with each other in order to form ambiguous (predeterminedly large) keys that are located also inside, and/or assigned, to these ambiguous (predeterminedly larger) keys. This is the case for example for the ambiguous (preferably large) key (50), located inside the ambiguous key (200), and which comes from the combination of the unambiguous keys “L/+”; “K/4” and “j/(”.

Let's suppose, as an example, that the user of the device (1) wants to enter (and/or type) the common word “home”. Consequently, the user is preferably going to enter this word, as a first step, by selecting the ambiguous (and/or preferably predictive) key (200), then the ambiguous (and/or preferably predictive) key (300), then the ambiguous (and/or preferably predictive) key (100) and finally the ambiguous (and/or preferably predictive) larger key (400). But for the purpose of this explanatory example, let's imagine that this previous ambiguous data entry system and/or apparatus of the device (1) shows the common word “come” instead of “home”, since the common word “come” could also be entered using the above described combination of ambiguous keys.

Let's also suppose that this ambiguous (and/or preferably predictive) system offers to the user the possibility to choose, and/or select, one of these two possible common word results. Consequently, as a second step, the user is going to select the area assigned to the unambiguous key (and/or possibly the area assigned to the ambiguous key) to which the data or letter “H” is assigned (in the instance the unambiguous key (88), and/or also possibly the ambiguous key (89)). By doing so, the user is in fact going to correct (and/or indicate) unambiguously (and/or character by character) at least the first letter (and/or at least one of the letter) of the common word he entered previously as a first step under the ambiguous data entry system mode of the ambiguous (predeterminedly larger) keys.

After the unambiguous (and/or preferably character by character) entry of the letter “H” by the user, the data entry system shows to the user the only possible result or choice of common word left, in the instance the word “home”. Please note also that most instances of mistyping of an unambiguous key are eliminated during this second step of corrective, and/or indicative, unambiguous (and/or preferably character-by-character) data entry system. Indeed, even if several unambiguous keys located next to each other are selected by mistyping at the same time, during this second step, the data entry system selects only the unambiguous key that is relevant to correcting (and/or indicating) the common word entered with the first step ambiguous (and/or preferably predictive) data entry system.

Moreover, please note that this corrective, and/or indicative, second step works also, in many instances, with the selection, and/or use, of the ambiguous (preferably large) keys. Indeed, even if several alphabetical characters are assigned to an ambiguous (preferably large) key, in many instances, only one of these alphabetical characters is deemed relevant by the ambiguous (and/or preferably predictive) software system of the device (1) in order to correct the first step data entry system done through the ambiguous (preferably larger) keys.

For example, only the letter “H” of the ambiguous (predeterminedly large) key (89) can be deemed relevant by the ambiguous (and/or preferably predictive) software system of the device (1) in order to correct the first result “come” into “home”. It is also very important to notice, from the FIG. 5, that the alphanumerical keyboard, and/or the alphanumerical keyboard locator, and/or their keys (and/or their characters, and/or their symbols, and/or their commands and/or their data) can be described as located, and/or placed, and/or divided, on and/or along at least substantial portions of preferably each one of the four corners of the device (1). Moreover, one can also notice, from the FIG. 5, that at least two of the ambiguous (preferably larger) keys are located on each side of the display.

This four corner arrangement of the keyboard locator (and/or keyboard) is made in order to spread in the most efficient manner the dimensions of the four ambiguous (preferably larger) keys (and their respective unambiguous and/or ambiguous keys) on the display (3), but also in order to indicate to the user the exact location of the four ambiguous (preferably larger) keys and their respective unambiguous (preferably small) and/or ambiguous (preferably large) keys (and/or characters, and/or symbols and/or commands and/or data) on the display (3). FIG. 5 illustrates an arrangement of at least four (predeterminedly larger) ambiguous keys on the display, and wherein at least two of the keys are located on each side of the display.

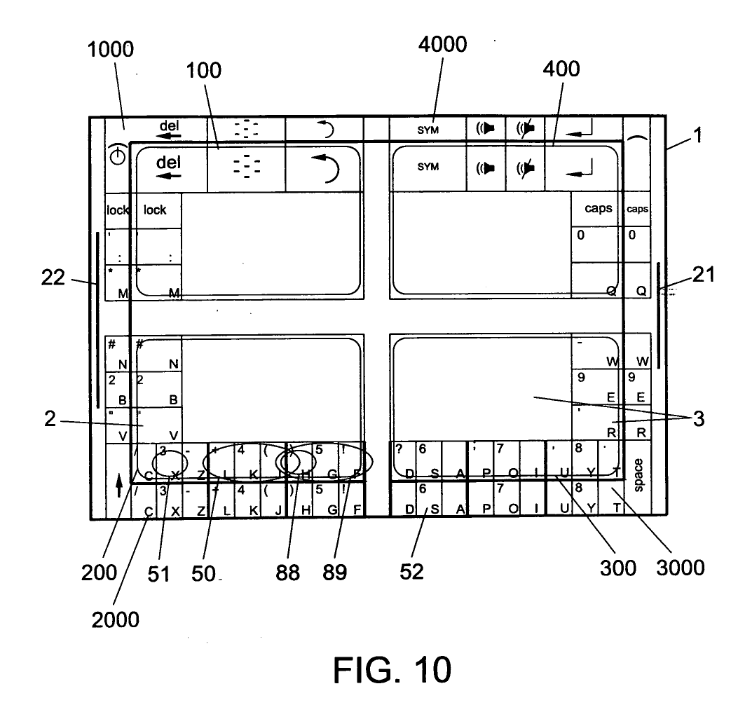

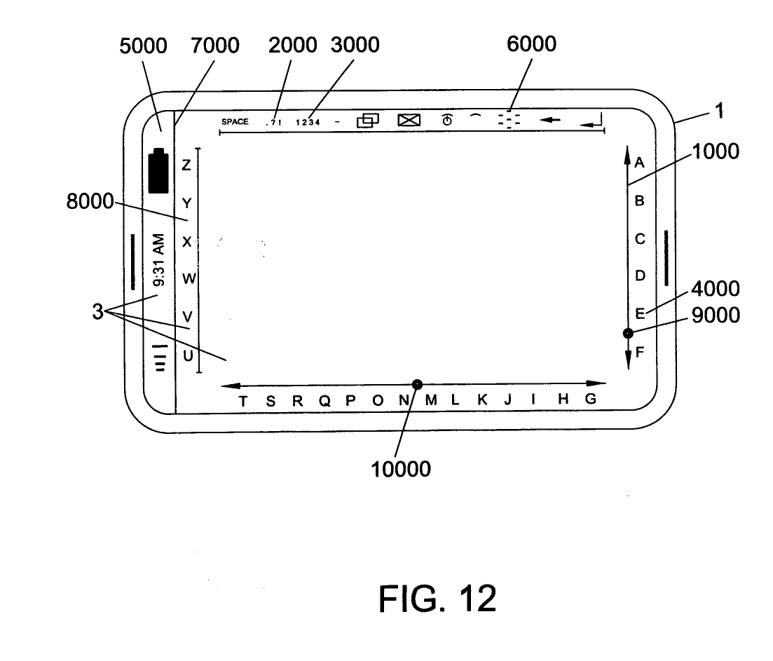

In a general manner, any type of keyboard, and/or any type of key/keyboard locator, described in this application, can be divided into at least two parts, preferably into four parts (please see the preferred embodiments depicted on FIG. 10 and FIG. 12). It is also important that each of these parts can extend at least on a substantial portion of each one of the four corners of the device (1). At least some of these preferably four parts (or at least two parts) of the keyboard and/or key/keyboard locator do not have to be necessarily connected to each other and/or touching each other (please see the preferred embodiments of FIG. 10 and FIG. 12). In fact, one can see from FIG. 10 and FIG. 12 that the alphanumerical keyboard is divided into a plurality of separate portions extending around the display.

For example, (not shown in the FIG. 5), there can be a material separation between these four parts (and/or at least two parts) of the keyboard and/or keyboard locator. In fact, in this instance, the keyboard and/or keyboard locator described in this application, do not have to necessarily extend all around the device (1) in a continuous manner (please see the preferred embodiments of FIG. 10 and FIG. 12).

Indeed, they can be divided in clear separate portions, and/or parts, extending each one of them around at least a substantial portion of several corners and/or at sides of the device (1) (please see the preferred embodiments of FIG. 10 and FIG. 12). As shown in the preferred embodiment of FIG. 10, one can see that the keyboard locator (52) and its corresponding image (and/or digital, and/or touch screen) keyboard (2) on the digital display (1) are divided into four separate portions (1000), (2000), (3000), and (4000). Each of these portions extends at least around a substantial part of each of the four corners of the device (1). The unambiguous (predeterminedly small) keys, and/or ambiguous (preferably large) keys, and/or ambiguous (predeterminedly larger) keys, can be assigned to each one of these four portions. Each one of these keys, of course, preferably works in the same manner as described in the FIG. 5.

As shown in FIG. 6, the unambiguous (and/or preferably character-by-character) data input system keys of the keyboard (2) can be of at least two different sizes: predeterminedly large unambiguous (and/or preferably character-by-character) keys (54), which are surrounded preferably on both sides by (and/or next to) two (generally, at least one) narrower unambiguous (and/or preferably character-by-character) keys (55) and (57); and predeterminedly narrower unambiguous (and/or preferably character-by-character) keys can be surrounded preferably on both sides by (and/or next to) two (generally, at least one) larger unambiguous (and/or preferably character-by-character) keys.

The keyboard (2) follows this narrow/wider (and/or small/big) unambiguous (and/or character-by-character) key pattern, preferably around and/or on at least a substantial portion of the display (3) of the device (1). The unambiguous (and/or preferably character-by-character) keys described above are preferably image (and/or digital, and/or touch screen) keys which have preferably at least a touch sensitive data entry system and/or apparatus, and are located on and/or around the display (3).

These unambiguous (and/or preferably character-by-character) keys are preferably copied on a hardware keyboard locator frame of the device (1) in order for the user to know where the keys are located; especially in the instance where this image (and/or digital, and/or touch screen) keyboard is invisible on the display (3). Further in this patent application, it is shown that such keyboard/key/character/symbol/data locator, herein called ‘keyboard locator’, can be situated and/or appear, not only on the hardware frame of the device, but also as an image on and around the display of the mobile telecommunication device. In fact, this description of keyboard (2) is also applicable if the keyboard locator is an image situated on and/or around the display (3).

At least part of the unambiguous (and/or preferably character-by-character) keys can also be hardware keys which have at least a mechanical and/or touch sensitive data entry system and/or apparatus, and can be located on the hardware frame of the device (1).

The goal of these at least two different shapes of unambiguous keys is to avoid mistyping instances of a key by the user. For example, in the case of the image (and/or digital, and/or touch screen) keyboard (2), and in order to avoid any mistyping, an algorithm of the software of the device (1) preferably decides that: first, if the surface of a narrow key is touched with the surface of two large surrounding keys, consequently the device enters the data assigned to the narrow key; second, if the surface of a large key is touched with the surface of at least one narrow key, consequently the device enters the data assigned to the large key.

The reason of the first algorithm instance is that the surface of the narrow (and/or small) key is predeterminedly narrow (and/or predeterminedly small) enough in order to make sure that the user's finger also touches the two predeterminedly large keys, located preferably on both sides of the predeterminedly narrow (and/or predeterminedly small) key, if the user's intention is to select the narrow (and/or small) key.

The reason of the second algorithm instance is that the combination of the surface of the large key with the two surfaces of the narrow (and/or small) keys, located preferably on both sides of it, is predeterminedly large enough in order to make sure that the user's finger does not touch another large key, if his intention is to select the large key.

The unambiguous (and/or preferably character-by-character) data entry system of these large/narrow keys can be coupled with an ambiguous (and/or preferably predictive) data entry system. This is especially true with the typing of common words. This ambiguous (and/or preferably predictive) system allows the user to avoid mistyping possibilities. It can also allow the user to avoid typing these common words fully character by character. Indeed, the software offers to the user at least one ambiguous (and/or preferably predictive) choice of a common word based on the first letters he enters unambiguously (and/or preferably character-by-character).

Moreover, the unambiguous (and/or preferably character-by-character) data entry system described in this instance, can correct, and/or supplement, and/or add, as a second step, any main data entry system and/or apparatus, and/or any arrangement of keys, which works mainly, as a first step, as an ambiguous (and/or preferably predictive) data entry system and/or apparatus. See the example of the ambiguous (and/or preferably predictive) key (56) derived from the arrangement of two narrow keys and one large key: the key (56) works as a first step preferably through an ambiguous (and/or preferably predictive) data entry system, but when necessary, the user enters any data (and/or character, and/or symbol, and/or command) of the key preferably through an unambiguous (and/or preferably character by character) data entry system by selecting individually any of the narrow and/or large keys forming the key (56).

Any correction, and/or addition, of characters (and/or symbols, and/or commands, and/or any other type of data) entered with said at least four (preferably larger) ambiguous keys can be done through unambiguous keys (having preferably one alphabetical character per key, and/or working preferably with a character-by-character data entry system) which are located on an additional alphanumerical keyboard (and/or on an additional alphanumerical keyboard locator) that appears as an image on and/or around the display of the device preferably when the user desires so. The user is able to make appear the image keyboard, and/or image keyboard locator, by any possible technical means, like for example: a double “click”, or a double “touch”, at the center of the screen of the device. Alternatively, this additional and/or separate keyboard could be also located on and/or around the hardware frame of the device.

Additionally, the unambiguous (and/or preferably character by character) keys of the keyboard (2) preferably work with at least two different data input systems. Typically and preferably, all along at least a substantial portion of the keyboard (2), one key working with one type of data input system and/or apparatus is surrounded by (and/or next to) at least one or two keys working with a different type of data input system and/or apparatus.

For example, a key (54) works with a touch sensitive data input system and/or apparatus with two surrounding keys (55) and (57) working with a “click” data entry input system and/or apparatus (please note that in this example the keys are preferably image (and/or digital, and/or touch screen) keys located on and/or around the display (3) of the device (1). This arrangement is provided to avoid mistyping of keys. As stated before, the keys of this arrangement can also be hardware keys preferably located on the hardware frame of the device (1) which extends around the edges of the display (3). Also, of course, this particular data input system and/or apparatus applies also to keyboard locators.

As displayed on FIG. 4 and FIG. 5, the ambiguous keys (preferably large and/or larger ones) can also have a data entry system and/or apparatus different from the one of the unambiguous (preferably small) keys. For example, the ambiguous key (50) could be activated with a touch sensitive data entry system on the display (3), whereas its unambiguous (preferably small) keys could be activated with a “touch and click” data entry system on the display (3) of the device (1).

As stated before, the keyboard locator (as noted, herein the term “keyboard locator” can also mean a key locator, and/or character locator, and/or symbol locator, and/or command locator, and/or any other data locator) is preferably located on the hardware frame of the device (1), though the term of ‘keyboard locator’ refers also to an image keyboard locator situated on and/or around the display (3). The keyboard locator extends preferably around at least a substantial portion of three or four sides and/or edges of the display (3). The keyboard locator indicates to the user the location of the preferably invisible image (and/or display, and/or digital, and/or touch screen) keys (having preferably at least a touch sensitive data entry system and/or apparatus) that are located on and/or around the edges (and/or the sides) of the display (3).

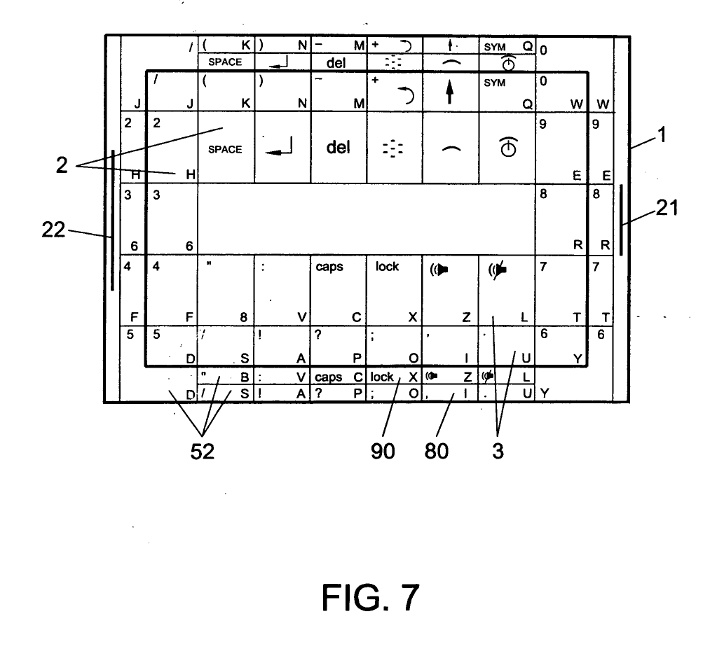

As shown in FIG. 7, the keyboard locator (52) can also indicate the location of other preferably invisible image (and/or digital, and/or touch screen) keys (herein the term “keys” can also include characters, and/or symbols, and/or commands, and/or any other type of data) that can be located anywhere on the display (3). Indeed, the keyboard locator can indicate the location of its preferably invisible keys located more toward the center of the display (3), and not only on and/or around the edges of the display (3).

Preferably, the keyboard locator indicates to the user the location of any of these preferably invisible image (and/or display, and/or digital, and/or touch screen) keys anywhere on the display (3) by showing the location preferably through the particular configuration (and/or particular placement, and/or particular arrangement) of any of the keys on the keyboard locator located on the hardware frame of the device (1) (and/or also possibly located on the display (3)).

For example, as shown in the preferred embodiment of the FIG. 7, the keyboard locator (52) (situated in this preferred embodiment on the hardware frame of the device (1)), or at least on a substantial portion thereof, has a two-row configuration. The keys of the keyboard locator are placed either on the higher row (80) or on the lower row (90). The keys placed on the higher row (80) represent preferably image (and/or digital, and/or touch screen) keys that are located on and/or around the edges (and/or sides) of the display (3), preferably perpendicularly to their respective key locator. The keys placed on the lower row (90) represent preferably image (and/or digital, and/or touch screen) keys that are located more toward the center of the display (3), preferably perpendicularly to their respective key locator. In fact, this two rows configuration of the keyboard locator (52) and its respective preferably invisible image (and/or digital, and/or touch screen) keyboard (2) allow the image (and/or digital, and/or touch screen) keyboard (2) to have large and comfortable preferably invisible image (and/or digital, and/or touch screen) keys having at least a touch sensitive data entry system and/or apparatus.

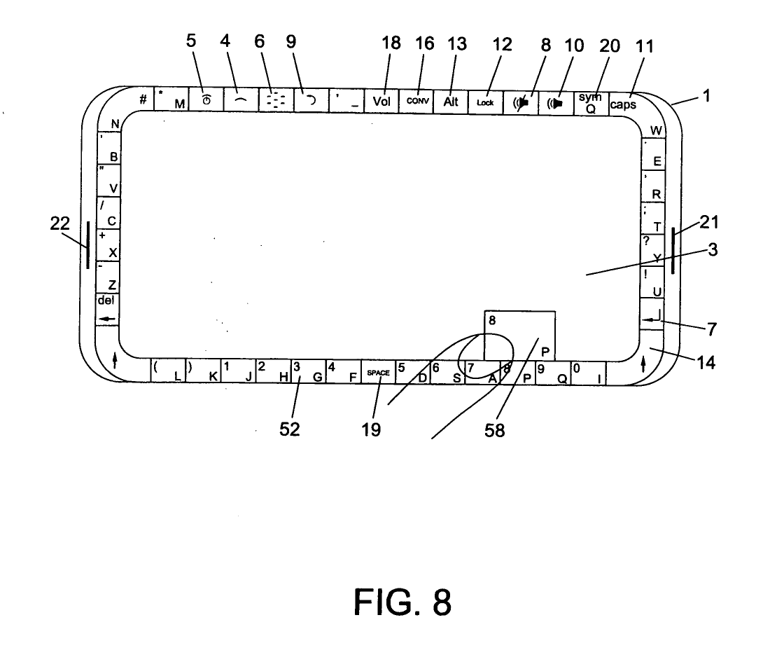

As previously stated, the keyboards (and/or keys, and/or characters, and/or symbols, and/or commands, and/or any other type of data) described in this application can be selected with any possible data entry system and/or apparatus. For example, as shown in the preferred embodiment of FIG. 8, at least part of the keys located on and/or around the display (3) can be selected (and/or at least activated in part) through at least one touch sensitive digital data entry system and/or apparatus, and/or through at least a “click” data entry system and/or apparatus, and/or through a data entry system and/or apparatus which detects the location of the tip of the finger of the user (and/or the tip of any other selecting means) over the display (3). Under the previous data entry systems and/or apparatus, the key located in the area below the tip of the finger (and/or the tip of any other selecting means), and/or the key touched by the user's finger, is selected and/or at least activated in part.

The user preferably knows the location of the preferably invisible image (and/or digital, and/or touch screen) keys because of the keyboard locator (52) situated preferably on the frame around the display (3). In an extension of the particular data entry systems and/or apparatus, the preferred invisible image (and/or digital, and/or touch screen) key (58) located below the tip of the finger (and/or the tip of any other selecting means), and/or touched by the user's finger, is activated at least in part by appearing, preferably in large dimensions, on the display (3) before the user “clicks” it in order to select it. This appearance of the image key (58) in large dimensions on the display (3) allows the user to make sure he clicks it and/or selects it, by any other means, without any possible mistyping.

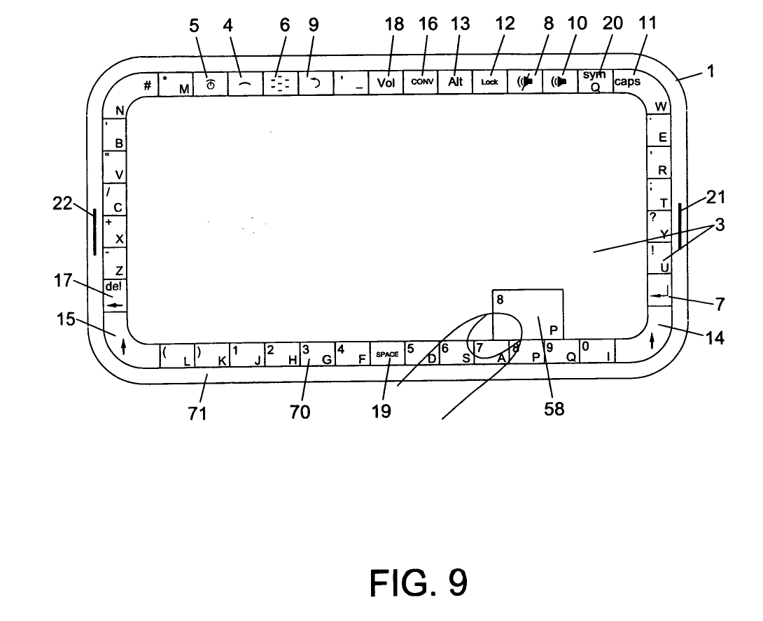

As previously mentioned, the keyboard locator is preferably shaped as a thin frame extending along at least a substantial portion of preferably at least three sides around the display (3). Its purpose is to indicate the location, on the display (3), of the preferably invisible (and predeterminedly larger) image keys (and/or image keyboard) of any characters, and/or symbols, and/or commands, and/or any other type of data, appearing on the keyboard locator. But the keyboard locator can additionally extend and appear preferably as an image on the display (3). As shown in FIG. 9), the image (and/or digital, and/or touch screen) keyboard locator unit (70) preferably has a predeterminedly thin and elongated shape extending on and/or around at least a substantial portion of at least three sides and/or edges of the display (3). The keyboard locator unit (70) is substantially an identical representation of an alphanumerical keyboard.

The space allocated to the image keyboard locator (and its image keys) on the display is preferably not a part of (and/or is preferably at least a part of) the space allocated to the invisible keyboard (and its keys) on the display. In other words, the image keyboard locator is preferably situated either near to, and/or contiguously to, and/or included at least in part of, the space allocated to the invisible alphanumerical keyboard on the display (3).

It is also possible to consider the frame shaped image keyboard locator as a visible part of the invisible frame shaped keyboard on the display. In fact, the image keyboard locator located on and/or around the display (3) preferably indicates the real and preferably invisible location, on the display (3), of the keys (and/or data entry system/apparatus) of the various characters, and/or symbols, and/or commands, and/or any other type of data that it shows and/or comprises.

Consequently, the preferably thin image (and/or digital, and/or touch screen) keyboard locator preferably does not take away from the space available on the display (3) for other purposes, like showing text and/or images of various software applications of the device. It is going to allow the keys (see example of key (58)) to be invisible and large on the display (3).

It is possible to imagine (as a preferred embodiment) that the surface of the invisible display keyboard along and/or around the display extends along and/or around both sides of the display keyboard locator (and/or along and/or both sides of a visible display keyboard having a thin and elongated shape). Moreover, if a display keyboard locator is an active keyboard, then the display keyboard locator can be considered (and/or named) in this patent application as a visible display keyboard having a thin and/or elongated shape. Moreover, and as a preferred embodiment only, please note that a thin and/or very thin visible display keyboard can be a keyboard which is made of a large invisible display keyboard from which only a portion in the shape of a thin and/or elongated image along and/or around the display is visible on the display.

The previous thin visible display keyboard entity can also, as a preferred embodiment only, be made from the combination of one predeterminedly large invisible display keyboard and one thin and/or elongated visible display keyboard, both keyboards extending along and/or around the sides of the display of the device. The previous visible display keyboard entity is activated when any surface of any of the two keyboards is selected by the user.

It's worth to note that it is possible to design a keyboard locator situated at least in part on the display (3) and/or at least in part on the hardware frame of the device (1).

An alphabetical keyboard, and/or an alphabetical keyboard locator, should be considered also alphanumerical if they carry (and/or respond to) at least one key (and/or command) relating to a numerical keyboard (and/or to numerical keys, and/or to numerical characters, and/or to numerical symbols, and/or to numerical commands, and/or to any other type of numerical data).

Conversely, a numerical keyboard, and/or numerical keyboard locator, should be considered also alphanumerical if they carry (and/or respond to) at least one key (and/or command) relating to an alphabetical keyboard (and/or to alphabetical keys, and/or to alphabetical characters, and/or to alphabetical symbols, and/or to alphabetical commands, and/or to any other type of alphabetical data). For example, as seen in FIG. 12, an image (a frame shaped and very thin) keyboard (1000), which has alphabetical characters extending around the display of the device, should be considered alphanumerical as long as it carries at least one switch key (3000) allowing the user to switch to a frame shaped numerical image keyboard.

Conversely, an image keyboard which has numerical keys extending around the display of the device should be considered alphanumerical as long as it carries at least one key allowing the user to switch to a frame shaped image alphabetical keyboard.

In some embodiments, the device (1) might not have any hardware frame. In this case, the keyboard locator, and/or keyboard of the device, is preferably an image (and/or digital, and/or touch screen) appearing on and/or around at least a substantial portion of preferably at least three or four sides and/or edges of the display.

In other embodiments, the device (1) can be made of, and/or carry, and/or support, a display material that is able to show (on the surface of the frame) the various images of different types of keyboard and/or keyboard locator configurations depending on what software applications the user is using on its device.

Where the keyboard, and/or the keyboard locator, are in the form of an image on and/or around the display (3), the image can, preferably at a user's option, remain permanently on and/or around the display, and this even if the user is switching (and/or changing, and/or using) various software applications on the device.

For example, if the user uses a text messaging software application in which a particular image keyboard locator appears on and around the edges of the screen of the device, and if the user switches now to an internet application on the device, consequently the previous image keyboard locator remains on and around the edges of the screen of the device, even though the software applications (and their images) are now different.

Optionally, the image keyboard, and/or image keyboard locator, is not necessarily permanent, and it might appear occasionally on the screen of the device (through any possible technical means) preferably at the discretion of the user. For example, the user wants to use an Internet search engine application on its device, consequently, by double clicking with its finger at the center of the screen of the device, the user makes the image of a peripheral alphanumerical keyboard locator appear on and/or around the screen.

Also, the image keyboard locator, and/or the image keyboard, can remain permanently, but with additional and/or other keys (and/or characters, and/or symbols, and/or commands, and/or any other type of data), along (and/or on, and/or around) the display of the device, depending on the software applications the user is switching to, and/or depending on which additional and/or other keys (and/or characters, and/or symbols, and/or commands, and/or any other type of data) are relating, useful or necessary for the proper use of each software application. This image alphanumerical keyboard, and/or keyboard locator, can be permanently associated with a number of keys associated with at least one of the predetermined number of software applications comprised in the device (1).

Please note also that the image of the frame keyboard, and/or the image of the frame keyboard locator, can be designed in a way that the image gives the impression that the keyboard and/or keyboard locator are (at least partly) transparent, and that the background images appearing on the display can be seen (preferably fully) through the keyboard and/or keyboard locator. Such design of the image keyboard, and/or image keyboard locator, can be done in order to make them appear as least invasive as possible on the display.

One issue of frame keyboard locators and of their respective invisible keyboards on the display is: what happens when an invisible key of an invisible keyboard is at least partly located on the same location (on the display) than another key and/or command displayed on the display of the device and belonging to another software application than said invisible keyboard.

In other words, which key the software system of the device is going to preferably select as a first choice? Is it the one of the invisible keyboard or the one of the other software application? One approach to answer this issue is to consider that the invisible key of the invisible keyboard is going to be selected preferably over the other key and/or command if the user selects other invisible keys of the invisible keyboard within a very short time frame. Indeed, this means that the user is preferably using its keyboard, and that it is probably entering a word and/or a text for example. If the user selects only one key, and/or makes only one selection, then the software of the device has to preferably consider that the user is probably specifically selecting the other key and/or command on the display.

Another approach to this issue is to make the invisible keyboard work with one type of data entry systems and/or apparatus, and/or to make the other keys and/or commands on the display work with another and/or different data entry system and/or apparatus. For example, the keys of the invisible keyboard (and/or keyboard locator) are going to be activated by a single “click” and/or “touch” on the screen, while at the same time the other displayed keys and/or commands, belonging to another software, are going to be selected by a double “click” and/or “touch” on the screen.

One of the main advantages of the frame image keyboard locator is that it can (as a preferred embodiment) extend as a very thin line, and as close as possible, along (and/or around, and/or on) a substantial portion of the edges of the display of the device. This advantage allows the frame shape image keyboard locator to be the least invasive as possible on the display, while at the same time its invisible frame shape keyboard offers to the user large and comfortable invisible keys to enter characters.

As already mentioned, this patent application does not limit itself to describing a frame image keyboard, and/or a frame image keyboard locator, that necessarily extend exactly along (and/or on and/or around) the edges of the display of the device. In fact, this patent application intends to protect the broader idea of a frame image keyboard, and/or frame image keyboard locator, that extend along (and/or on and/or around) the sides of the display, and not necessarily its edges.

Indeed, as seen in FIG. 12, if at least one edge (5000) of one side of the display (3) is already occupied by various images appearing on it, then one can perfectly imagine that the very thin frame shaped image keyboard (1000) (and/or the frame shaped image keyboard locator) described in this patent application could perfectly extend along that same side, but not along its occupied edge space (5000), but preferably along and/or next to the border line (7000) located between this occupied edge space (5000) on the display and the space (8000) on the display left open and/or unoccupied by these images.

Therefore, according to the invention:

First, a keyboard locator (image one and/or hardware one) extends along (and/or on, and/or around) at least a substantial portion of at least one side, or at least a substantial portion of at least two sides, of the display of the device.

Second, an invisible keyboard, and/or an invisible alphanumerical keyboard, extends along (and/or on, and/or around) at least a substantial portion of at least one side, or at least a substantial portion of at least two sides, of the display of the device.

Third, a rectangular shape display having a perimeter, wherein a keyboard extends around at least a portion of said perimeter, and said keyboard is a screen image of an alphanumerical keyboard appearing on said display.

Fourth, a thin image alphanumerical keyboard extends along (and/or on, and/or around) at least a substantial portion of at least one side, or at least a substantial portion of at least two sides, of the display of the device. The non-invasive thin (and/or very thin) design of the elongated and/or linear alphanumerical keyboard is possible because it is preferably a one row peripheral image keyboard which is not surrounded by any keys. Consequently, it becomes unnecessary to design the keys of the keyboard with large dimensions as it was the case previously in order to avoid mistyping instances with surrounding keys. A predeterminedly thin key is preferably a key whose height (but not length) is approximately of minimal possible dimensions. More precisely, and as a preferred embodiment, the height of a thin key belonging preferably to a thin and/or non-invasive alphanumerical keyboard and/or keyboard locator (peripherally extending around at least a substantial portion of the display) is approximately equal to the height of a visible alphabetical character (and/or numerical/command/symbol character) appearing or comprised on said key (on at least one side of the display of the device). In the same manner, and as a preferred embodiment, a thin and/or non-invasive alphanumerical keyboard and/or keyboard locator (peripherally extending around at least a substantial portion of the display) can be defined as a keyboard or keyboard locator comprising keys (on at least one side of the display of the device) whose height (but not length) are approximately equal to the height of the alphanumerical characters (and/or numerical/command/symbol characters) said keys comprise. Preferably, the height or size of an alphabetical character (and/or numerical/command/symbol character) of a thin alphanumerical keyboard or keyboard locator is approximately equal to the minimal or smallest size possible for said character to be visible and/or readable comfortably by a majority of users. A thin elongated key of a thin alphanumerical keyboard or keyboard locator comprising several alphabetical characters (and/or numerical/command/symbol characters) preferably has these characters placed or appear next to each other following the length direction of this elongated key rather than following the height direction of said key, in order to keep the height of said key as minimal or thin as possible.

Fifth, an image keyboard extending along (and/or on, and/or around) at least a substantial portion of at least one side, or at least a substantial portion of at least two sides, or at least a substantial portion of at least three sides, or at least a substantial portion of four sides, of the display of the device, and wherein only a small and/or thin portion of the image keyboard is visible. It should be noted that the small and/or thin visible portion of the image keyboard is preferably located toward and/or along the edge side of the display in order for the image keyboard to be the least invasive on the display.

It's worth to note that one could consider that the image keyboard, and/or the image keyboard locator, extending along (and/or on, and/or around) the display of the device are in fact also extending along (and/or on, and/or around) at least a substantial portion of a rectangular (or square) software application window appearing on the display. Indeed, a predetermined application of the device (1) is usually represented by a rectangular (or squared) window appearing on the display. Consequently, one can imagine an alphanumerical keyboard, and/or keyboard locator, represented in the form of an image on the display that extends along and/or around at least a portion of the sides of the rectangular (or squared) window.

Consequently, the frame shaped image keyboards, and/or the frame shaped image keyboard locators, are capable also of being minimized, and/or maximized, and/or restored down, and/or resized, and/or closed, on the display of the device, preferably in the same manner (and/or preferably at the same time) than the application windows that they are surrounding.

The alphanumerical keyboard (image one and/or hardware one) that extends along (and/or on, and/or around) preferably at least a substantial portion of at least three sides, or at least a substantial portion of four sides, of the display of the device, can be made from the combination of at least one keyboard (or set of keys/characters/commands/symbols/data) which extends along (and/or on, and/or around) at least one side of the display of the device, and b/ at least one keyboard locator (or set of keys/characters/commands/symbols/data locators) which extends along (and/or on, and/or around) at least one side of the display of the device.

As mentioned above, the idea of a frame shaped image keyboard locator (and/or frame shaped image keyboard, and/or frame shaped invisible keyboard) should not only apply to strict alphanumerical ones. Indeed, all of the ideas and basic principles described and developed in this patent application for the frame shaped alphanumerical image keyboard locator (and/or frame shaped alphanumerical image keyboard, and/or frame shaped alphanumerical invisible keyboard) are preferred embodiments only, and could also be applied to the following main types of frame shaped image keyboard locators (and/or frame shaped image keyboard, and/or frame shaped invisible keyboard) that could be created or tailored for the particular use of the following software applications: menu application ones, phone call application ones, email application ones, messages application ones, interne application ones, navigation/maps application ones, music application ones, video application ones, video recording/camera application ones, instant messaging application ones, software applications for office works ones, video games application ones, and so forth since this list is not limitative.

Each frame shaped image keyboard locators (and/or frame shaped image keyboards, and/or frame shaped invisible keyboards) has also the possibility to carry various switch keys that can switch to other types of particularly tailored frame shaped image keyboard locators (and/or frame shaped image keyboards, and/or frame shaped invisible keyboards) and/or to other types of particular software applications like for example the “Menu” application switch key (6000) of FIG. 12.

The particular frame shaped image “Menu” keyboard locator (and/or frame shaped “Menu” image keyboard, and/or frame shaped “Menu” invisible keyboard) can carry keys that can switch potentially to an infinity of other types of frame shaped image keyboard locators (and/or frame shaped image keyboards, and/or frame shaped invisible keyboards) and/or to an infinity of other types of particular software applications. Indeed, the frame shaped image “Menu” keyboard locator (and/or frame shaped “Menu” image keyboard, and/or frame shaped “Menu” invisible keyboard) can potentially carry an infinity of software applications keys that can switch to an infinity of software applications that have a frame shaped image keyboard locator particular to them (and/or a frame shaped image keyboard particular to them, and/or frame shaped invisible keyboard particular to them).

Also, there can be numerous frame shaped image “Menu” keyboard locators (and/or frame shaped “Menu” image keyboards, and/or frame shaped “Menu” invisible keyboards) since they can potentially carry an infinity of software application keys.

As noted above, the image and/or display keyboard entity (2) of FIG. 3 can be designed partly visible around at least a substantial portion of at least one side, or around at least a substantial portion of at least two sides, or at least a substantial portion of at least three sides, or at least a substantial portion of at least four sides of the display (3) of the device (1).

Indeed, as described in length in the preferred embodiment of FIG. 3 above, the keyboard (2) can be invisible in part through its invisible keyboard unit (27), but it can also be visible in part through its visible keyboard locator unit (26). In fact, these two units and/or components and/or parts (the invisible one and the visible one), when they are both located on the display (3), are forming together a display and/or image keyboard (2) entity which can be described as partly visible on the display. In fact, it could be said that the alphanumerical keyboard (2) is an image keyboard partly visible on the display (3), and that the visible part of this image keyboard (2) extends along and around at least a portion of at least one side of the display, preferably in a predeterminedly thin and elongated shape.

As a preferred embodiment, the visible part of the display and/or image keyboard extends around (and/or on, and/or along) the sides (and/or edges) of the display (3), preferably in thin and elongated manner. The visible part of the display keyboard is preferably located toward the “edge of the display” side of the display keyboard. Also, one can say that this patent application is describing at least two display keyboards, one visible and the other one invisible, extending around at least a substantial portion of at least one side, the display (3) of the device (1), and preferably forming together a display keyboard which is at least partly visible around at least a substantial portion of at least one side, of the display (3).

An alphabetical character, and/or a numerical character, and/or any other type of character/symbol appearing on any key of the image keyboard locator, could (under this preferred embodiment of my patent) be typed and/or entered on the screen, if (in the preferred embodiment of a screen working with touch sensitive data entry system and/or apparatus) the surface (on the screen) of the key of the image keyboard locator is at least touched, and/or if the surface (on the screen) of the key on the invisible keyboard is at least touched, and/or if both of the previous surfaces (on the screen) are at least touched at the same time. Of course the ideas developed in the preferred embodiment should also be applicable to image keyboard locators, and to invisible keyboards, working with any other type of data entry system and/or apparatus than the touch sensitive one.

In some embodiments, not only a thin frame shaped image keyboard locator can be designed, but also a non-invasive and thin frame shaped image keyboard. As seen in the preferred embodiment of FIG. 12, this image keyboard (1000) can be in the shape of at least one thin (and/or very thin) line extending along (and/or on, and/or around) a substantial portion of preferably at least three sides, or a substantial portion of preferably four sides, of the display of the device. In this preferred embodiment, the keys of the image keyboard are preferably in the shape of a line. The characters (alphabetical, and/or numerical, and/or commands, and/or symbols) assigned to these linear keys (which form together a line), appear preferably next to them (see example of character 4000).

This keyboard (1000) becomes then almost completely invasive and invisible because it is shaped around at least a substantial portion of the sides of the display (3), and because of the thin linear shape of its keys. Please note that the very thin linear shape of this frame shape image keyboard (1000) can also be applied to image keyboard locators. As a preferred embodiment, these keys are activated when the line that forms them is at least touched by the user's finger.

In some embodiments of the invention, an image keyboard (preferably an alphanumerical one) extends along (and/or on, and/or around) at least a substantial portion of preferably three sides or four sides of the display of the device, whereas in other embodiments a thin image keyboard (preferably an alphanumerical one, and preferably, but not necessarily, in the shape of a thin line) can be utilized, which extends along (and/or on, and/or around) at least a substantial portion of preferably three sides or four sides of the display of the device. Indeed, the thin shape allows the image keyboard to be the least invasive as possible (and/or non-invasive), especially when it extends around the sides and/or edges of the display. This thin shape concept is a major improvement when compare to actual image keys which are visible and of large dimensions and consequently very invasive on the actual digital touch screen display. In fact, as depicted in FIG. 12, the alphanumerical keyboard (1000) is in the form of a non-invasive and predeterminedly thin shape image, and wherein the alphanumerical keyboard extends along and around at least a portion of at least one side of the display (3).

It should be noted that the thin (and/or very thin) linear shape concept of the keyboard and/or keyboard locator (either image one and/or hardware one) is only a preferred embodiment of the idea of a non-invasive thin frame shaped keyboard, and/or keyboard locator. Indeed, the thin frame shaped keyboard, and/or keyboard locator, can have an infinity of shapes and/or designs. For example, one can imagine that a thin frame shaped image keyboard locator is made of small keys (following each other) that have (for each one of them) an oval or round shape. For example, one can also imagine that the thin frame shape image keyboard (1000) of FIG. 12 would be made of its image alphanumerical characters only, extending along the sides of the display of the device, but without the need of any linear keys next to them.

The frame shaped image keyboard, and/or the frame shaped image keyboard locator, can, as a preferred embodiment, be either near to, and/or contiguous to, and/or included at least in part of, the horizontal and/or vertical scroll bars extending around the display and/or its application window. Conversely, the horizontal and/or vertical scroll bars can, as a preferred embodiment, be either near to, and/or contiguous to, and/or included at least in part of, the frame shaped image keyboard, and/or the frame shaped image keyboard locator extending around the display and/or its application window (please see scroll boxes 9000 and 10000 of the preferred embodiment of FIG. 12).

All various ideas described in this patent application relating to keyboard locators can be apply not only to keyboard locators situated at least on and/or around the hardware frame of the device, but also to keyboard locator located (and/or appearing) at least on and/or around the display of the device. Any ideas in this patent application describing and/or relating to keyboard locators situated on and/or the hardware frame of the device should also be considered as being applicable to image keyboard locators as long as these ideas can technically work with image keyboard locators extending on and/or around the display as well. In this patent application, keyboard locators located on the hardware frame should always be considered as preferred embodiments only of the general keyboard locator concept and invention.

The concept developed in this patent application of a frame shaped software image extending around the sides of the display of the device (and/or around the sides of an application window appearing on the display) should not only be limited to displaying image software keyboards and/or image software keyboard locators of various software applications.

Indeed, this idea of a frame shaped software image can also be used for displaying an infinity of other types of images (and/or data) like (for example, but not limited to) advertisement images, and/or SMS advertisements, and/or multimedia advertisement messages, and/or text messages, and/or emails, and/or instant messages, and/or news messages, and so forth.

This is an idea of a software application for displaying images not in a conventional “window” rectangular shape software application, but instead in a new thin and/or elongated software application image extending preferably around and/or along at least a substantial portion of three sides or four sides, of the display of the device. Preferably, this idea can also be described as a software application for preferably a mobile telecommunication device including a display having a perimeter, said software application displays advertisement images and/or advertisement messages on said display in a predeterminedly elongated shape, said software application extending along and around at least a portion of said perimeter.

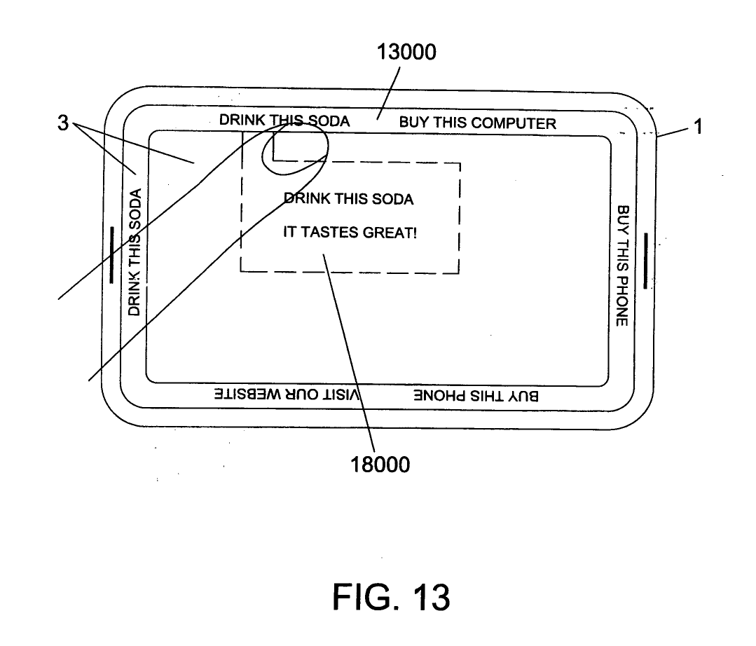

One of the main advantage for displaying various images (and/or data) in this fashion is that it allows the images not to be invasive to the other applications images appearing at the center part of the display of the device (which is not the case of actual advertisement banner images which are very invasive on the display). At the same time, the surface area available for displaying images and messages with this particular software application will be larger than the surface area of a regular or conventional advertisement banner. Moreover, this idea of a frame shaped image application could be very useful to advertisers, publishers, device manufacturers, service providers (and/or any other entity with an interest) who could use this non-invasive way to advertise, especially on mobile telecommunication devices; and in exchange users could get rewarded for example by free and/or discounted telecommunication services and/or devices, if they would agree to receive these non-invasive advertisement images. Indeed, as seen in preferred embodiment of FIG. 13, this preferably fixed and preferably predetermined frame shaped image software application (13000) extending along (and/or on, and/or around) the display (3) of the device (1) is an excellent way for service providers to display and/or publish advertisements on the display (3) in the least invasive manner.

In a preferred embodiment, the frame shaped software application (13000) can show more than one advertisement image and/or message. In another preferred embodiment, the advertisement images and/or messages could be published by any entity on the display of the mobile telecommunication device, but preferably by the service provider for the device. In another preferred embodiment, the frame shaped image software application should be thin enough to be the least invasive on the display, and it should also be large enough to show in the most efficient manner the various images and/or messages of the advertisement. In another preferred embodiment, if the user selects any advertisement appearing on this frame shaped image application (13000) then the advertisement preferably opens in the form of a conventional window application (18000) on at least a substantial portion of the display (3). In another preferred embodiment, the advertisement images and/or messages turn and/or run around the sides of the display (3) of the device (1), preferably in a continuous ‘circular’ motion, so that new advertisements could appear on the frame shaped image software application (13000) preferably in a continuous motion without disturbing the images of the main window application located at the center of the display (3). In another preferred embodiment, this frame shaped application image could remain permanently on the screen of the device, even if for example the user scrolls vertically and/or horizontally the main window application appearing at the center of the screen, or also even if for example the user switches application windows and/or switches software applications on the device.

Moreover, this frame shaped application image is a more visible and a more balanced manner to advertise on the screen than the more invasive advertisement banners and advertisement posters used actually in mobile advertising. It is also very important to remember that all the ideas and principles described in this patent application, when describing the frame shaped image keyboard and the frame shaped image keyboard locator, should also be applicable to this frame shaped application image for displaying preferably advertisement images as long as these ideas and principles could be considered as useful and technically applicable to the frame shaped application image.

I claim:

1. A processing device, having a face side, said device comprising a display and a keyboard, wherein said keyboard peripherally extends around at least a portion of said display.

2. The device according to claim 1, wherein said keyboard is an alphanumerical keyboard, said display has a perimeter, and said keyboard extends around at least a portion of said perimeter.

3. The device according to claim 2, wherein said display has a rectangular shape with two longitudinal and two transversal sides; said alphanumerical keyboard extends at least around a portion of one said longitudinal side and a portion of two said transversal sides; said device has a speaker located on one said transversal side and a microphone located on the other said transversal side.

4. The device according to claim 2, wherein said alphanumerical keyboard has a predetermined keyboard set of keys, and said device further comprising a keyboard locator unit having a locator set of keys corresponding to said predetermined keyboard set of keys, the keys of said locator set of keys are disposed in a manner to indicate the locations of the keys of said predetermined keyboard set of keys.

5. The device according to claim 2, wherein the alphanumerical keyboard has keys comprising only one alphabetical character per key.

6. The device according to claim 2, further comprising a microphone located on one end of the face side of said device, a speaker located on the other end of the face side, wherein said display extends from the vicinity of said microphone to the vicinity of said speaker, and wherein the alphanumerical keyboard extends around at least a portion of at least three sides of said display.

7. The device according to claim 2, wherein said display has a rectangular shape, and said keyboard is a screen image of an alphanumerical keyboard appearing on said display.

8. The device according to claim 4, wherein said alphanumerical keyboard is a visual representation of said predetermined set of keys located within a predetermined space allocated on said display, said keyboard predetermined set of keys comprises keys invisible to the user, said keyboard locator unit is situated on the face side of said device, said keyboard locator unit is arranged as a representation of said alphanumerical keyboard in order to indicate to the user the exact location of the invisible keys of said keyboard predetermined set of keys on and around said display.

9. The device according to claim 4, further comprising a hardware frame, wherein said keyboard locator unit is situated on and around said hardware frame, and/or appears as an image on and around said display.

10. The device according to claim 8, wherein said keyboard locator unit has a predeterminedly thin and elongated shape and is substantially an identical representation of said alphanumerical keyboard.

11. The device according to claim 8, wherein said keyboard locator is situated contiguously to, or near to, or included at least in part of, the space allocated to the alphanumerical keyboard on the display.

12. The device according to claim 8, wherein the keyboard locator unit extends around at least a portion of the perimeter of said display.

13. The device according to claim 2, wherein the following options are provided:
a) said alphanumerical keyboard is represented by an image keyboard appearing on the display, said image keyboard having image keys; or
b) said device further comprises a hardware frame, and said alphanumerical keyboard is made as a hardware keyboard extending on the frame, said hardware keyboard having hardware keys; or
c) said alphanumerical keyboard is represented by a combination of the image keys and the hardware keys.

14. The device according to claim 13, wherein the alphanumerical keyboard of the option (a) is at least a digital touch screen data entry keyboard, and/or the alphanumerical keyboard of the option (b) is at least a mechanical “push down” data entry keyboard, and/or the alphanumerical keyboard of the option (c) is a combination of the digital touch screen data entry keyboard or a combination of the mechanical “push down” data entry keyboard.

15. The device according to claim 2, wherein the alphanumerical keyboard comprises keys having at least one of the following characters: numerical characters, command characters, and symbol characters.

16. The device according to claim 2, wherein the alphanumerical keyboard comprises keys having only one alphabetical character per key, and wherein the keys are unambiguous keys, which enter unambiguous characters.

17. The device according to claim 2, wherein the alphanumerical keyboard comprises keys having at least two alphabetical characters per key, and wherein the keys are ambiguous keys, which enter ambiguous characters.

18. The device according to claim 2, wherein the alphanumerical keyboard comprises at least four ambiguous keys.

19. The device according to claim 18, further comprising
a hardware frame and an additional alphanumerical keyboard and/or keyboard locator unit associated with said alphanumerical keyboard, said additional alphanumerical keyboard and/or said keyboard locator unit comprising a predetermined number of unambiguous keys having one alphabetical character per key, and
wherein the correction, and/or the addition of characters entered with said at least four ambiguous keys is done through said additional alphanumerical keyboard and/or keyboard locator unit, and wherein said additional keyboard and/or keyboard locator unit either appears, at the discretion of the user, as an image on and/or around the display, and/or is located on and/or around said hardware frame.

20. The device according to claim 18, wherein the alphanumerical keyboard is located on and/or along at least portions of the four corners of said device or of said display, and/or wherein at least two of said ambiguous keys are located on each side of the display.

21. The device according to claim 2, further comprising a predetermined number of software applications; said alphanumerical keyboard comprises a number of keys associated with at least one application of said predetermined number of software applications.

22. The device according to claim 21, wherein the alphanumerical keyboard is represented as an image situated on and around the display, and wherein said image, at the discretion of the user, either: a) appears occasionally, or: b) remains permanently on the display, or: c) is permanently associated with said number of keys associated with said at least one application.

23. The device according to claim 21, wherein a predetermined application of said predetermined number of software applications is represented as a rectangular window appearing on the display, and wherein the alphanumerical keyboard is represented in the form of an image appearing on said display, wherein said image extends along and/or around at least a portion of the sides of said rectangular window.

24. The device according to claim 2, wherein the alphanumerical keyboard is divided into a plurality of separate portions extending around the display.

25. The device according to claim 2, wherein the alphanumerical keyboard is an image keyboard partly visible on said display, and wherein the visible part of the image keyboard extends along and around at least a portion of at least one side of the display, in a predeterminedly thin and elongated shape.

26. The device according to claim 2, wherein the alphanumerical keyboard is in the form of a non-invasive and predeterminedly thin shape image, and wherein the alphanumerical keyboard extends along and around at least a portion of at least one side of the display.

27. The device according to claim 2, wherein the alphanumerical keyboard is an unambiguous keyboard having only one alphabetical character per key, and wherein said keys are arranged one after the other in at least one of the following orders: a) a regular alphabetical order; b) a continuous Qwerty order; c) at least one of the three alphabetical rows of a conventional unambiguous Qwerty keyboard is assigned to at least one specific side of the device.

28. A software application for a mobile telecommunication device including a display having a perimeter, said software application displays advertisement images and/or advertisement messages on said display in a predeterminedly elongated shape, said software application extending along and around at least a portion of said perimeter.
